(19) United States
(12) Patent Application Publication
(10) Pub. No.: US 2026/0105697 A1
(43) Pub. Date: Apr. 16, 2026

(54) EXTENDED REALITY SYSTEM FOR ENHANCING USER EXPERIENCE USING AI ASSISTANT AND METHOD THEREOF

(71) Applicant: Lee

(72) Inventors: Mingun LEE, Cupertino, CA (US); Hyunseo LEE, San Jose, CA (US); Hajin JANG, San Jose, CA (US); Jaehee JUNG, San Jose, CA (US)

(21) Appl. No.: 18/911,678

(22) Filed: Oct. 10, 2024

(51) Int. Cl. G06T 19/00; G06F 9/451; G09B 5/02; H04N 23/66; H04N 23/695

(52) U.S. Cl. CPC G06T 19/006; G06F 9/453; G09B 5/02; H04N 23/66; H04N 23/695

(57) ABSTRACT

The present invention relates to an XR (Extended Reality) device that communicates with an external camera. The device comprises one or more processors and memory storing programs configured to execute specific instructions. These instructions include accessing an application server, executing an application, receiving reference model data, and displaying the user's current posture alongside the reference model's corresponding posture. Additionally, the device can display enlarged portions of the user's and reference model's postures either side by side or in an overlapping manner. The device also includes functionality for controlling the external camera's position, angle, zoom, or height. Furthermore, the device facilitates communication with the user through an AI assistant, which manages the application progress based on user interactions. The device can switch its point of view between the external camera's perspective and its own, either according to user preference or automatically.

### TECHNICAL FIELDS

The present invention pertains to an XR device that interacts with an external camera, wearable devices, personal data servers, application servers, sports devices, and home appliances. It features an AI assistant capable of communicating with the user and delivering various three-dimensional experiences through the device's internal display.

### BACKGROUND

The development of computer systems for augmented reality has advanced significantly in recent years. Augmented reality environments typically include virtual elements that either replace or enhance the physical world. Input devices like cameras, controllers, joysticks, touch-sensitive surfaces, and touchscreen displays are used to interact with these environments.

### SUMMARY

This invention describes technology that captures an XR (Extended Reality) device user through an external camera connected to the XR device, displays it on the XR device's internal display, and various embodiments using the technology. This invention also describes a technology for controlling the user's XR device, peripherals connected to the XR device, or applications running on the XR device using biometric data sent from the user's wearable device or the user's personal data sent from the user's personal data server. In addition, the XR device, according to this invention, is equipped with an AI assistant that can understand all biometric data and personal information of the XR device user and use it to control applications running on XR devices, peripherals of XR device and XR devices through conversation with the XR device user.

### BRIEF DESCRIPTION OF THE DRAWING

The detailed description is described with reference to the accompanying figures. In the figures, the left-most digit(s) of a reference number identifies the figure in which the reference number first appears. The same reference number in different figures indicates a similar or identical component or feature.

FIG. 1 is a pictorial diagram depicting an extended reality environment for operating an XR (Extended Reality) device in accordance with this invention and its various embodiments.

FIG. 2 is a block diagram depicting an extended reality system where an XR device is connected to multiple other devices either over a network or directly.

FIG. 3 is a block diagram illustrating functional blocks constituting the XR device.

FIG. 4 is a block diagram depicting a controller of an XR device designed to manage and coordinate the user's XR experience according to this invention and its embodiments.

FIG. 5A-5D illustrate example techniques for capturing a user wearing an XR device with an external camera and displaying the captured image on the internal display of the same XR device. These figures also show various embodiments where these techniques are applied.

FIG. 6A-6D illustrate example techniques for communication between an external person and an XR device user, where the external person views the XR device's internal display content through an external display. These figures also show various embodiments where these techniques are applied.

FIG. 7A-7C illustrate example techniques for switching between the external camera's point of view and the XR device's point of view while a user is operating the XR device. These figures also show various embodiments where these techniques are applied.

FIG. 8A-8C illustrate example techniques for controlling an XR device using biometric data from the user's wearable device or personal data from the user's personal data server. These figures also show various embodiments where these techniques are applied.

FIG. 9A-9C illustrate example techniques for controlling a home appliance using biometric data from the user's wearable device or personal data from the user's personal data server. These figures also show various embodiments where these techniques are applied.

FIG. 10A-10C illustrate example techniques for controlling a sports device using biometric data from the user's wearable device or personal data from the user's personal data server. These figures also show various embodiments where these techniques are applied.

FIG. 11A-11C illustrate example techniques for controlling a second wearable device using biometric data from the user's wearable device or personal data from the user's personal data server. These figures also show various embodiments where these techniques are applied.

FIG. 12A-12E illustrate example techniques for controlling application progress using biometric data from the XR device user's wearable device or personal data from the user's personal data server. These figures also show various embodiments where these techniques are applied.

FIG. 13A-13G illustrate example techniques for controlling the progress of another application using biometric data from the XR device user's wearable device or personal data from the user's personal data server. These figures also show various embodiments where these techniques are applied.

### DESCRIPTION OF EMBODIMENTS

This application outlines techniques and features for visually representing relationships in an extended reality environment using natural user inputs, such as speech. The term “virtual environment” or “extended reality environment” refers to a simulated space where users can fully or partially immerse themselves. This can include virtual reality, augmented reality, mixed reality, and more. These environments feature interactive objects and elements. Typically, users engage with these environments using a computing device, such as a dedicated XR (Extended Reality) device. An XR device 102 is defined as a computing device with extended reality capabilities, capable of displaying an extended reality graphical user interface. It can show various visual elements within this interface and accept user inputs targeting these elements. Examples of XR devices include virtual reality devices, augmented reality devices, and mixed reality devices, among others. Essentially, any device capable of presenting a full or partial extended reality environment falls under this category.

In some embodiments, an extended reality system can present extended reality content (such as virtual reality (VR), augmented reality (AR), or mixed reality (MR)) to a computing device like an XR device 102. Alternatively, the XR device 102 itself may implement the extended reality system. This system can receive speech input from the XR device 102 and interpret its semantic meaning, often using a neural network trained for this purpose. It can identify a first term from one part of the speech input and a second term from another part, defining relationships between objects, concepts, or characteristics to be displayed in the extended reality environment. Consequently, the system can automatically generate a three-dimensional (3D) representation of these relationships and provide it to the computing device for display. This allows users to control and modify the extended reality environment using speech inputs, offering greater interaction freedom compared to conventional input methods.

In some embodiments, the three-dimensional environment visible via the internal display 302 of the XR device 102 is a virtual environment containing virtual objects and content positioned at various locations within the three-dimensional space without representing the physical environment. Alternatively, the three-dimensional environment may be a mixed reality setting, where virtual objects are displayed at different positions within the three-dimensional space, constrained by physical aspects of the real world (e.g., walls, floors, surfaces, gravity, time of day, and spatial relationships between physical objects). In other cases, the environment may be augmented reality, representing the physical world. Here, the physical environment's objects and surfaces are represented at different positions within the three-dimensional space, maintaining the spatial relationships of the real world. When virtual objects are placed relative to these representations, they appear to have corresponding spatial relationships with the physical objects and surfaces. The computer system can transition between different types of environments (e.g., varying levels of immersion, adjusting the prominence of audio/visual inputs from virtual content and the physical environment) based on user inputs and contextual conditions.

In some embodiments, the extended reality content includes an object, and the system associates the first and second terms with this object. The system may then modify the object based on these terms, creating a modified object that forms the basis of the 3D representation. Thus, users can use speech inputs to alter the characteristics, locations, and presence of objects within the extended reality environment.

In some embodiments, the internal display 302 of the XR device 102 shows different views of the three-dimensional environment based on user inputs or movements that alter the virtual position of the current viewpoint relative to the environment. When the environment is virtual, the viewpoint can move through navigation or locomotion requests (e.g., in-air hand gestures or hand movements) without needing the user to move their head, torso, or the internal display 302 in the physical world. Alternatively, movements of the user's head, torso, or the internal display 302 or other location-sensing elements (e.g., when holding the internal display 302 or wearing the HMD) relative to the physical environment cause corresponding changes in the viewpoint's position, direction, speed, and orientation in the three-dimensional environment, thus altering the displayed view. If a virtual object has a fixed spatial relationship to the viewpoint (e.g., is anchored to it), moving the viewpoint will move the virtual object within the three-dimensional environment while maintaining its position in the field of view (e.g., the virtual object is “head-locked”).

In some embodiments, a virtual object is anchored to the user's body and moves relative to the three-dimensional environment when the user moves entirely within the physical environment (e.g., when carrying or wearing the internal display 302 of the XR device 102 and/or other location-sensing components of the computer system). However, it does not move in the three-dimensional environment in response to the user's head movements alone (e.g., the internal display 302 of the XR device 102 and/or other location-sensing components rotating around a fixed point on the user's body in the physical environment). Additionally, in some embodiments, a virtual object may be optionally anchored to another part of the user, such as the hand or wrist, and moves within the three-dimensional environment in accordance with the movement of that part in the physical environment, maintaining a predetermined spatial relationship between the virtual object's position and the virtual position of that part in the three-dimensional environment. Furthermore, in some embodiments, a virtual object is anchored to a predetermined portion of the field of view provided by the internal display 302 of the XR device 102 and moves within the three-dimensional environment in accordance with the movement of the field of view, regardless of user movements that do not alter the field of view.

In some embodiments, users can interact with virtual objects in the three-dimensional environment using one or both hands, as if these virtual objects were real objects in the physical environment. For instance, as previously described, the computer system's sensors can capture the user's hands and display their representations within the three-dimensional environment, similar to how real-world objects are displayed. Alternatively, in some embodiments, the user's hands are visible through the display generation component, allowing the physical environment to be seen through the user interface due to the transparency or translucency of a portion of the internal display 302 of the XR device 102. This can also be achieved by projecting the user interface onto a transparent or translucent surface or directly onto the user's eye or into their field of view. Consequently, the user's hands are displayed at corresponding locations within the three-dimensional environment and are treated as objects capable of interacting with virtual objects as if they were physical objects. Additionally, the computer system can update the display of the user's hand representations in the three-dimensional environment in real time, in accordance with the movement of the user's hands in the physical environment.

In some embodiments, the extended reality system receives an indication from the computing device regarding the user's gaze direction or pose relative to the extended reality content. For instance, the system associates the first and second terms with an object based on determining that the object lies within the path of the user's gaze or pose. Incorporating gaze and/or pose as additional inputs can refine the system's actions in conjunction with speech input, such as identifying which of multiple objects the user is referencing in their speech to determine the object a pronoun refers to, among other tasks.

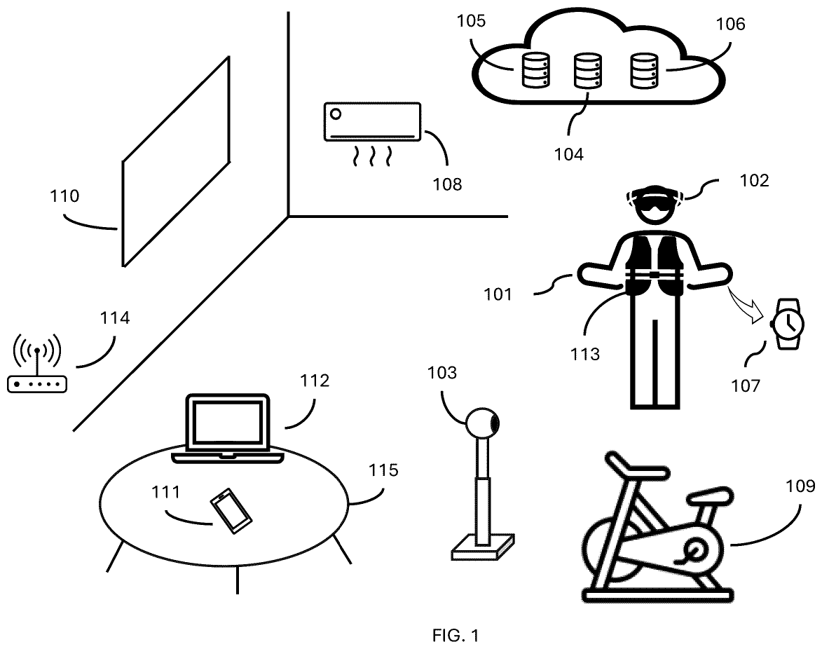

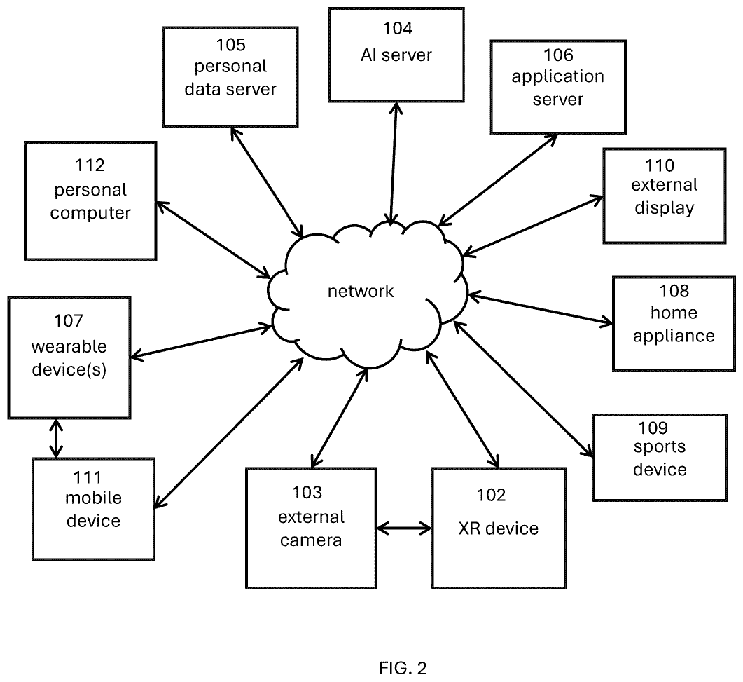

FIG. 1 is a pictorial diagram illustrating the operating environment of an extended reality (XR) device in accordance with this invention and its embodiments. FIG. 2 is a block diagram depicting the relationship between an XR device 102 and multiple other devices connected either over a network or directly to the XR device 102. As shown in FIG. 1 and FIG. 2, the user is wearing an XR device 102 along with other wearable devices 107, 113. Surrounding the user are various other devices, such as an external camera 103, sports device 109, external display 110, home appliance 108, mobile phone 111, personal computer 112, network device 114, personal data server 105, and AI server 104. These devices are connected to the XR device 102 either through a network or directly, providing the user with a variety of virtual reality experiences.

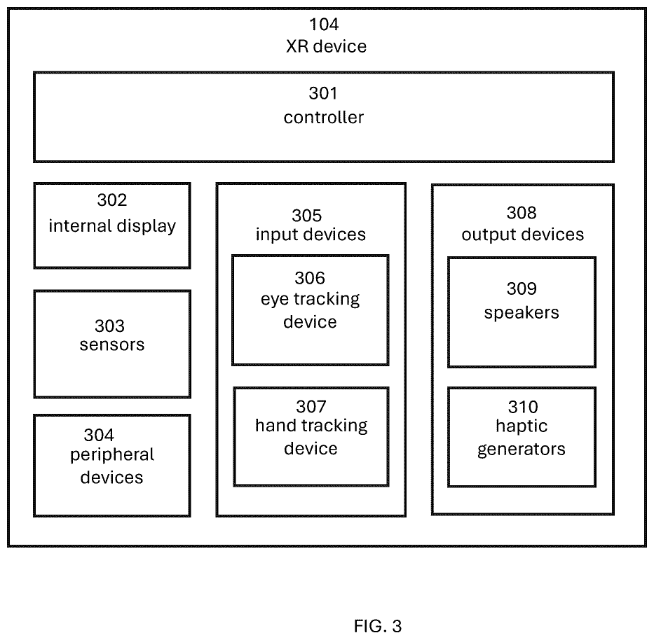

FIG. 3 is a block diagram illustrating the functional components within the XR device 102. The XR device 102 comprises a controller 301, an internal display 302, one or more input devices 305 (e.g., a gaze tracking device, a hand tracking device 307, and other input devices 305), one or more output devices 308 (e.g., speakers 309, haptic generators 310, and other output devices 308), and various sensors (e.g., image sensors, light sensors, depth sensors, tactile sensors, orientation sensors, proximity sensors, temperature sensors, location sensors, motion sensors, or velocity sensors). Additionally, it can be optionally connected to one or more peripheral devices 304 (e.g., an external camera 103, wearable devices 107, 113, home appliances 108, external displays 110, or sports devices 109).

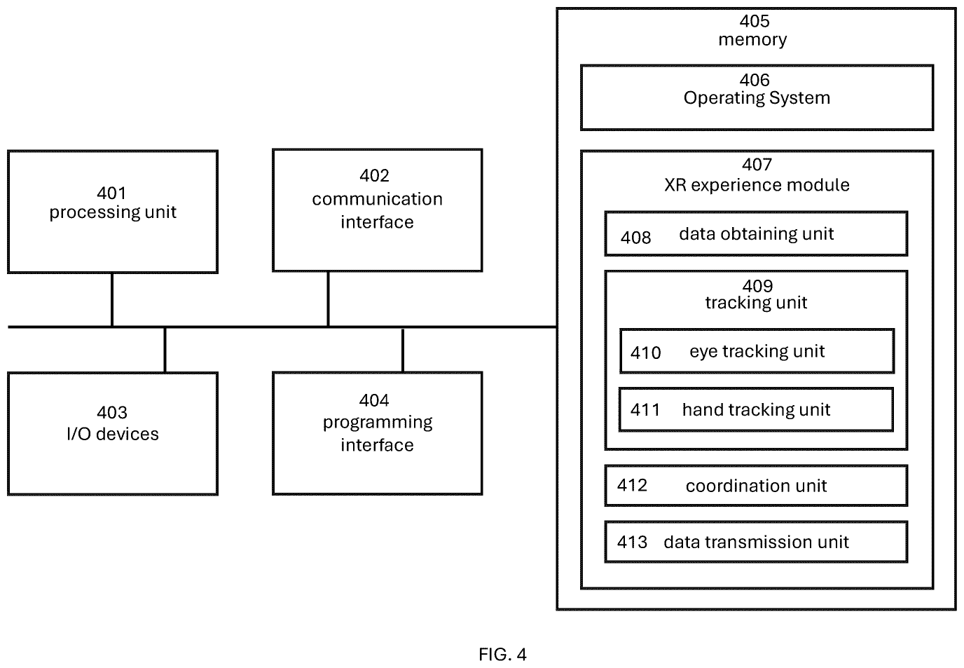

In some embodiments, the controller is designed to manage and coordinate the XR experience for the user. This controller may comprise an appropriate combination of software, firmware, and/or hardware. Detailed information about the controller is provided in FIG. 4. The internal display 302 is configured to deliver the XR experience to the user, including at least the visual component. This display may also consist of a suitable combination of software, firmware, and/or hardware. In some cases, the functionalities of the controller are integrated with or provided by the internal display 302. The internal display 302 may feature two optical modules (e.g., first and second display assemblies, not shown), one for the user's right eye and another for the left eye, presenting slightly different images to each eye to create a three-dimensional effect.

In some embodiments, the gaze tracking device (not shown) is utilized to monitor the position and orientation of the user's gaze relative to the scene or the XR content displayed via the internal display 302 of the XR device 102. This eye-tracking device may include at least one eye-tracking camera (e.g., infrared (IR) or near-IR (NIR) cameras) and illumination sources (e.g., IR or NIR light sources such as an array or ring of LEDs) that emit light towards the user's eyes. The eye-tracking cameras are directed toward the user's eyes to capture the reflected IR or NIR light. The device can capture images of the user's eyes (e.g., as a video stream at 60-120 frames per second (fps)), analyze these images to generate gaze-tracking information, and communicate this information to the controller. In some embodiments, each of the user's eyes is tracked separately by respective eye-tracking cameras and illumination sources. Alternatively, in some embodiments, only one of the user's eyes is tracked by a respective eye-tracking camera and illumination sources.

In some embodiments, a hand-tracking device is used to monitor the position and movement of one or more parts of the user's hands relative to the scene (e.g., the surrounding physical environment, the internal display 302, or parts of the user such as the face, eyes, or head), or relative to a coordinate system defined by the user's hand. The hand-tracking device 307 may include image sensors (e.g., IR cameras, 3D cameras, depth cameras, and/or color cameras) that capture three-dimensional scene information, including the user's hand. These sensors capture images with sufficient resolution to distinguish the fingers and their respective positions. The image sensors output a sequence of frames containing 3D map data (and possibly color image data) to the controller, which extracts high-level information from the map data. This information is typically provided via an Application Program Interface (API) to an application running on the controller, which drives the internal display 302 accordingly. For example, the user may interact with software on the controller by moving their hand or changing their hand posture. Additionally, a haptic generator 310 may be used to provide physical feedback, such as vibrations, to notify the user of certain situations or events.

FIG. 4 is a block diagram illustrating a controller of an XR device 102 designed to manage and coordinate the user's XR experience in accordance with this invention and its embodiments. While specific features are depicted, those skilled in the art will recognize that various other features have not been illustrated for simplicity and to avoid obscuring more pertinent aspects of the disclosed embodiments. As a non-limiting example, the controller 301 may include one or more processing units 401 (e.g., microprocessors, application-specific integrated circuits (ASICs), field-programmable gate arrays (FPGAs), graphics processing units (GPUs), central processing units (CPUs), processing cores, etc.), one or more input/output (I/O) devices 403, one or more communication interfaces 402 (e.g., universal serial bus (USB), FireWire, Thunderbolt, IEEE 802.3x, IEEE 802.11x, IEEE 802.16x, global system for mobile communications (GSM), code division multiple access (CDMA), time division multiple access (TDMA), global positioning system (GPS), infrared (IR), Bluetooth, Zigbee, etc.), one or more programming (I/O) interfaces, a memory 405, and one or more communication buses for interconnecting these and various other components.

In some embodiments, one or more communication buses include circuitry that interconnects and manages communications between system components. The I/O devices 403 may include a keyboard, mouse, touchpad, joystick, microphones, speakers 309, image sensors, displays, and similar devices. The memory 405 comprises high-speed random-access memory, such as dynamic random-access memory (DRAM), static random-access memory (SRAM), double-data-rate random-access memory (DDR RAM), or other random-access solid-state memory devices. Additionally, the memory may include non-volatile memory, such as magnetic disk storage devices, optical disk storage devices, flash memory devices, or other non-volatile solid-state storage devices. The memory 405 can also include storage devices located remotely from the processing units 401. It comprises a non-transitory computer-readable storage medium. This memory or storage medium may store various programs, modules, and data structures, including an optional Operating System 406 and an XR experience module 407.

The Operating System 406 includes instructions for handling various basic system services and for performing hardware dependent tasks. In some embodiments, the XR experience module 407 is configured to manage and coordinate one or more XR experiences for one or more users (e.g., a single XR experience for one or more users or multiple XR experiences for respective groups of one or more users). To that end, in various embodiments, the XR experience module 407 includes a data obtaining unit 408, a tracking unit, a coordination unit 412, and a data transmitting unit.

In some embodiments, the data obtaining unit 408 is designed to acquire data (e.g., presentation data, interaction data, sensor data, or location data) from at least the internal display 302, and optionally from one or more input devices 305, output devices 308, sensors, and/or peripheral devices 304. To achieve this, the data obtaining unit 408 includes the necessary instructions, logic, heuristics, and metadata. Additionally, the tracking unit 409 is configured to map the scene and track the position/location of at least the internal display 302 with respect to the scene depicted in FIG. 1 and, optionally, to one or more input devices 305, output devices 308, sensors, and/or peripheral devices 304. The tracking unit 409 also includes the required instructions, logic, heuristics, and metadata. In some embodiments, the tracking unit 409 comprises a hand-tracking unit 411 and/or an eye-tracking unit 410. The hand tracking unit 411 is designed to monitor the position/location and movements of one or more parts of the user's hands relative to the scene in FIG. 1, the internal display 302, and/or a coordinate system defined by the user's hand. The eye tracking unit 410 is configured to track the position and orientation of the user's gaze (or, more broadly, the user's eyes, face, or head) relative to the scene (e.g., the physical environment and/or the user, such as the user's hand) or the XR content displayed via the internal display 302.

In some embodiments, the coordination unit 412 is designed to manage and coordinate the XR experience presented to the user via the internal display 302 and, optionally, through one or more output devices 308 and/or peripheral devices 304. To achieve this, the coordination unit 412 includes the necessary instructions, logic, heuristics, and metadata. Additionally, the data transmitting unit is configured to transmit data (e.g., presentation data or location data) to at least the internal display 302 and, optionally, to one or more input devices 305, output devices 308, sensors, and/or peripheral devices 304. This unit also includes the required instructions, logic, heuristics, and metadata. Although the data obtaining unit 408, the tracking unit (including the eye tracking unit 410 and the hand tracking unit 411), the coordination unit 412, and the data transmitting unit 413 are depicted as residing on a single device (e.g., the controller), it should be understood that in other embodiments, any combination of these units may be distributed across separate computing devices.

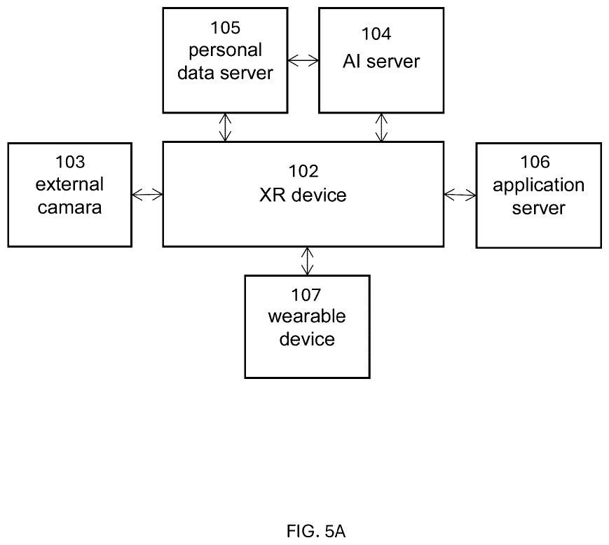

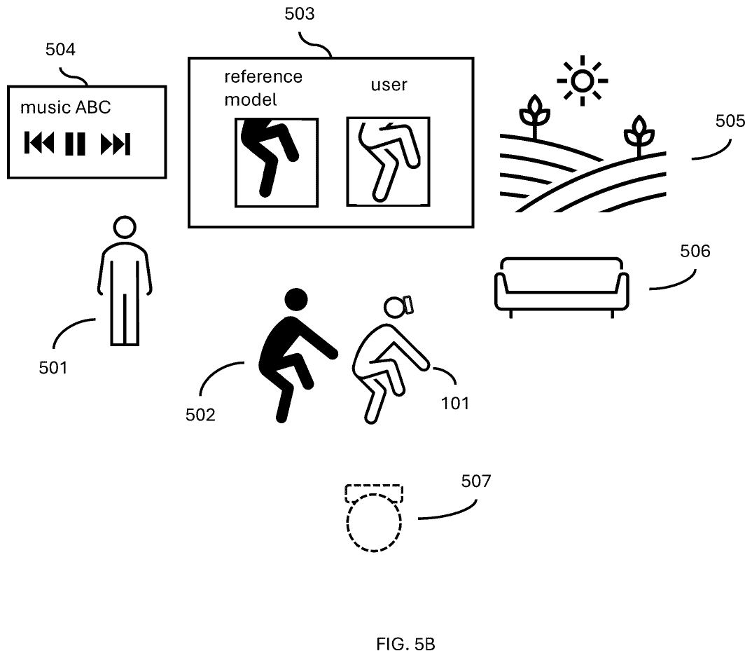

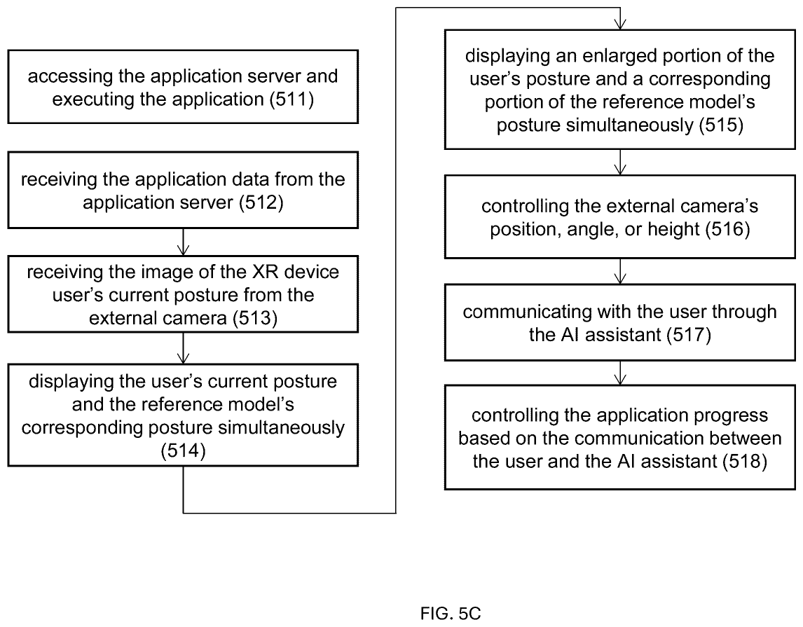

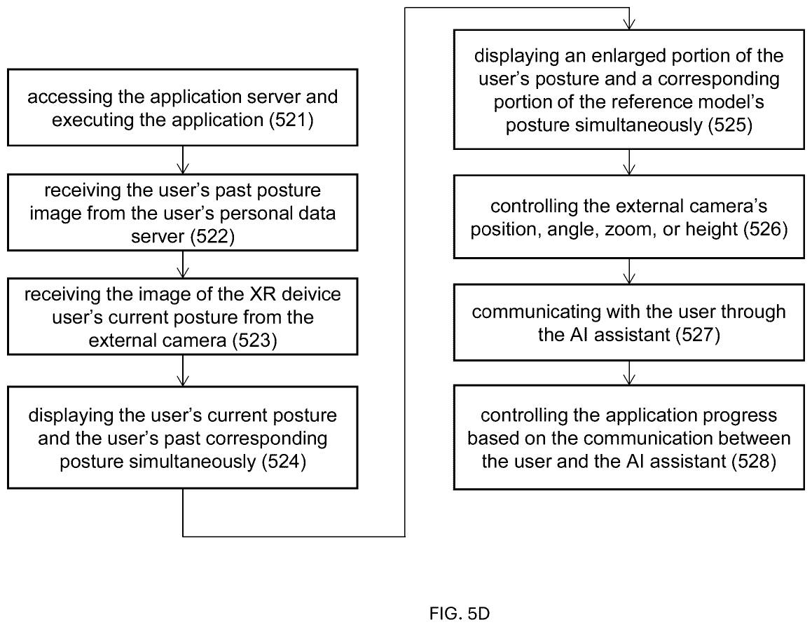

FIG. 5A illustrates a block diagram for capturing a user wearing an XR device 102 with an external camera 103, displaying the captured user's image on the internal display 302 of the same XR device 102, and performing various embodiments using the captured user's image. As shown in FIG. 5A, the XR device 102 is connected to the AI server, personal server, application server 106, external camera 103, and wearable device through a network or directly. The AI server 104 is a powerful computing system designed to handle the computational demands of artificial intelligence tasks. It features advanced CPUs, such as Intel Xeon or AMD EPYC processors, providing the necessary computational power to manage complex AI models and large datasets. The AI server 104 is also equipped with GPUs that are crucial for AI workloads, accelerating the training and inference processes of AI models. These GPUs are particularly effective for tasks like image classification, object detection, and speech recognition. Additionally, the AI server 104 has high-speed memory, including DDR5/6 or High Bandwidth Memory (HBM), to efficiently manage and process vast amounts of data. It also includes specialized software optimized for AI computations, such as machine learning, deep learning, and natural language processing applications. The AI server 104 is designed to quickly process and analyze large datasets, making it suitable for tasks requiring significant computational power and data throughput. Overall, the AI server 104 plays a critical role in running complex algorithms and supporting a wide array of resource-intensive AI workloads, making it essential for modern AI infrastructure.

An application server 106 is a cloud-based server that hosts applications and makes them available on the user's device over the network. The application server 106 includes processors, memory, an Operating System 406, and a network module for running and storing applications and communicating with user devices. Applications can be executed entirely on the application server 106, but in some cases, portions of the application may be performed on the user's device based on data sent from the application server 106. For example, in the case of an indoor workout application, the user device may execute parts of the workout application by receiving data such as the application routine, reference model 502, background image 505, or background music from the application server 106.

A personal data server 105 allows individuals to store, manage, and control their personal data. Users can store personal data such as biometric data from wearable devices, daily activity data, or schedule data from mobile phones 111, personal computers 112 or IoT devices, and medical records provided by healthcare institutions.

The external camera 103 is positioned separately from the XR device 102 and comprises a camera support and a camera body. The camera body includes control mechanisms, a lens, an image sensor, and a communication unit. Consequently, the image captured by the image sensor can be transmitted to the XR device 102 in real time via a wireless communication unit (e.g., Wi-Fi, Bluetooth, NFC, IR, Zigbee, etc.). The camera support may feature mechanisms for movement, height adjustment, and angle adjustment to capture the target object from various positions, heights, and angles. For clarity, the image may consist of both still and moving images. Additionally, the external camera 103 may include a depth sensor alongside the camera module, enabling the wireless transmission of both image and depth information to the XR device 102.

Wearable devices, commonly referred to as “wearables,” are electronic gadgets designed to be worn on the body. They are equipped with various sensors, including heart rate sensors, temperature sensors, sweat sensors, and blood pressure sensors. These devices integrate technology into everyday accessories and clothing, offering functionalities such as health monitoring and fitness tracking. Various types of wearable devices, including smartwatches, fitness trackers, smart clothing, and smart rings, are currently available on the market.

FIG. 5B illustrates a three-dimensional environment visible to the user via the internal display 302 of the XR device 102 for performing yoga. In this environment, the user's image, captured by the external camera 103, is displayed alongside an AI assistant 501, a GUI 503 screen, a reference model 502, and a background image 505.

An AI assistant 501, also known as a virtual assistant or digital assistant, is a software application that leverages artificial intelligence to assist users with various tasks. The AI assistant 501 employs technologies such as Natural Language Processing (NLP), enabling it to understand and interpret human language, both spoken and written. It also utilizes Machine Learning (ML), allowing the assistant to learn from interactions and enhance its responses over time, and Natural Language Understanding (NLU), which helps the assistant comprehend the context and intent behind user queries. The AI assistant 501 offers various functions and capabilities, including Task Automation, where it can automate routine tasks such as setting reminders, sending emails, and managing calendars; Information Retrieval, where it can provide information on a wide range of topics, from weather updates to answering complex questions; Personalization, where it learns user preferences to offer personalized recommendations and responses; and Conversational Interaction, where it simulates human conversation, making interactions more natural and intuitive.

In some embodiments of this invention, the AI assistant 501 possesses capabilities in generative AI, multi-modal AI, autonomous AI, and multi-agent AI. Generative AI refers to a type of artificial intelligence that can create new content, such as text, images, audio, video, and even software code, based on the data it has been trained on. This technology utilizes deep learning models, which are neural networks with many layers capable of learning complex patterns and relationships in data, and large language models (LLMs), a subset of deep learning models specifically designed for text generation. Notable examples include OpenAI's GPT-3 and GPT-4, which can generate human-like text based on a given prompt

Multimodal AI refers to artificial intelligence systems capable of processing and integrating information from multiple types of data or modalities, such as text, images, audio, and video. This capability enables these systems to achieve a more comprehensive understanding and generate more robust outputs. Multimodal AI employs technologies such as machine learning models that can handle different types of data simultaneously. These models include convolutional neural networks (CNNs) for images, recurrent neural networks (RNNs) for sequences, transformers for both text and images and data fusion techniques that combine data from different modalities to create a unified representation. This approach helps capture more context and reduce ambiguities

Autonomous AI is an advanced form of artificial intelligence that can perform tasks and make decisions without human intervention. It operates through a combination of advanced technologies, including machine learning, natural language processing (NLP), and real time data analysis. Autonomous AI begins by gathering data from various sources, such as customer interactions, transaction histories, and external databases. This data collection is essential for understanding the context of each task and making informed decisions. By utilizing machine learning algorithms, autonomous AI analyzes the collected data to identify patterns and predict outcomes, using this information to make decisions that align with its goals.

For example, an autonomous AI in customer service might analyze past interactions to determine the best way to respond to a customer's query. After making a decision, the autonomous AI executes the necessary actions to achieve the desired outcome. This could involve answering customer questions, processing sequences, or escalating complex issues to human agents. The execution process is designed to be efficient and seamless, ensuring a smooth customer experience. One of the critical features of autonomous AI is its ability to learn from each interaction. It continuously updates its knowledge base and refines its decision-making algorithms to improve performance. This adaptability allows it to handle an ever-increasing range of tasks and scenarios. Some examples of what autonomous AI can do are as follows: Customer Interaction: Autonomous AI can analyze customer data and offer personalized recommendations and solutions to enhance the customer experience. For example, it can suggest products based on past purchases or provide tailored advice based on a customer's preferences. Proactive Support: Autonomous AI can anticipate users'needs and provide proactive support, such as sending reminders for upcoming appointments or notifying customers about potential issues before they arise. Multi-Channel Management: Autonomous AI can manage user interactions across multiple channels, including email, chat, social media, and phone.

Multi-agent AI refers to systems where multiple autonomous agents interact and collaborate to achieve specific goals. These agents can be software programs, robots, or even humans working together within a shared environment. In multi-agent AI, each agent operates independently, making decisions based on its own perceptions and objectives while communicating and coordinating with other agents to solve complex problems that exceed the capabilities of a single agent. This approach allows multi-agent AI to handle tasks more quickly and efficiently by distributing the workload among multiple agents. It can also scale up rapidly by adding more agents to manage larger or more complex tasks and adapt to changes in the environment or task requirements.

According to the present invention, the AI assistant 501 may be implemented on the AI server 104, or some functionalities of the AI assistant 501 may be implemented on the XR device 102. As shown in FIG. 5B, the AI assistant 501 can be displayed on the internal display 302 of the XR device 102 in the form of a person or any other digital representation. The appearance of the AI assistant 501 can be selected according to the user's preference through the XR device 102's graphical user interface (GUI) 503 or via the user's voice command to the XR device 102.

FIG. 5B illustrates a scene viewed by the user through the internal display 302 of the XR device 102, where the user performs yoga exercises according to a yoga application transmitted from the application server 106. In this scene, the external camera 103 captures the user performing the yoga exercises and transmits the captured image to the XR device 102 in real time. The XR device 102 then displays the transmitted image on the internal display 302 in real time, allowing the user to see their postures from the perspective of the external camera 103 through the XR device 102 they are wearing. As depicted, the user can observe their yoga exercise from the external camera's 103 perspective and simultaneously view the posture of the reference model 502 performing the yoga exercise beside them. The reference model 502 is a visualization of data transmitted from the application server 106 and is programmed to demonstrate reference postures for each step of the yoga exercises, enabling users to efficiently follow and perform the postures.

As shown in FIG. 5B, the XR device 102 can use the GUI 503 to display an enlarged portion of the user and a corresponding enlarged portion of the reference model 502 side-by-side. The enlarged portion may be selected based on the area with the most significant difference between the user's pose and the reference model's 502 pose, or it may be chosen based on the user's interest, which can be detected through the eye tracking device 306 of the XR device 102. This feature allows the user to more clearly understand the differences between their posture and the reference model's 502 posture.

The AI assistant 501 in FIG. 5B, as described above, possesses capabilities in generative AI, multi-modal AI, autonomous AI, and multi-agent AI. Consequently, the AI assistant 501 in this embodiment can understand the user's personal data (e.g., activity history, schedule, medical records) from the personal data server 105, biometric data (e.g., heart rate, body temperature, sweat levels, stress score) from the user's wearable device, internal data (e.g., image data displayed on the internal display 302, status data of internal components) of the XR device 102, and application data (e.g., application routine, reference model 502, background image 505, background music) from the application server 106. Based on this understanding, the AI assistant 501 can communicate with the user through conversation or the GUI 503 and control the XR device 102 and peripheral devices 304.

For example, the AI assistant 501 can discuss the differences between the user's posture and the reference model's 502 posture, suggesting adjustments to help the user match the reference model's posture. In another embodiment, the XR device 102 may display the user's past posture alongside their current posture instead of the reference model's 502 posture. By comparing these postures, the user can easily recognize changes over time. To facilitate this, the user's past data may be stored in advance on the personal server or application server 106.

FIG. 5C illustrates the flowcharts for simultaneously displaying the user's current posture and the reference model's 502 posture and controlling the application's progress based on the communication between the AI assistant 501 and the user. In step 511, the XR device 102 accesses the application server 106 for user authentication procedures. After authentication, the application is executed on the XR device 102; however, in some embodiments, the application can be executed on the application server 106. Additionally, in some embodiments, the application can be executed on both the application server 106 and the XR device 102 in combination.

In step 512, the XR device 102 receives application data from the application server 106. This data includes various components of the application, such as the application routine, reference model 502 data, background images 505, and background music. The application routine outlines the content and timing of sessions within the application. For instance, an indoor bodyweight workout application might include 15-minute sessions of leg squats, shoulder raises, and lunges. Similarly, a yoga application might feature 5-minute sessions of Mountain Pose, Downward-Facing Dog, and Warrior Pose.

The reference model 502 data provides a model for the user to follow while using the application. In a yoga application, this could be a virtual model demonstrating ideal poses for each step, while in a bodyweight workout application, it could be a virtual model showing the correct form for each exercise. Background images 505 and music are media content displayed or played on the device running the application. Multiple background images or music tracks can be assigned to different stages of the application. Users can select these based on their preferences, or the device can automatically choose them by referencing data stored on the user's personal server or transferred from the user's wearable device.

In step 513, the XR device 102 captures an image of the user using an external camera 103. In some cases, this camera is equipped with a 3D sensor, allowing it to transmit 3D sensing data of the user to the XR device 102. In step 514, the XR device 102 uses the data from steps 512 and 513 to display both the user's current posture and the corresponding posture of the reference model 502 simultaneously. For example, if the user performs the Downward-Facing Dog pose in a yoga application, the reference model 502 will also display the Downward-Facing Dog pose. This matching can be achieved through application routine data or image analysis of the user's pose

In step 515, the XR device 102 can display an enlarged view of both the user's posture and the corresponding posture of the reference model 502 simultaneously. The enlarged portion may be chosen based on the greatest difference between the user's posture and the reference model's posture, or it may be selected based on the user's interest, which can be detected through the XR device's eye tracking feature. This helps the user to more clearly understand the differences between their posture and the reference model's posture. In step 516, the XR device 102 adjusts the position, angle, or height of the external camera 103. Sometimes, it may be necessary to capture a detailed image of a specific part of the user by moving the external camera 103. Therefore, the XR device 102 can command the external camera 103 to move to a specific position or to change its shooting angle or height. The external camera 103 is equipped with mechanisms to adjust its position, angle, and height.

In step 517, the XR device 102 communicates with the user through the AI assistant 501. This communication can occur via voice or a graphical user interface (GUI) 503 displayed on the internal display 302 of the XR device 102. The AI assistant 501 can identify issues in the user's posture and suggest solutions or additional training to address these problems. In another scenario, the AI assistant 501 might access the user's medical records stored on the user's personal server and recognize a shoulder injury. In this case, the AI assistant 501 could recommend skipping shoulder-related poses to protect the user's health. In step 518, the XR device 102 adjusts the application's progress based on the interaction between the user and the AI assistant 501. For instance, if the user wants to repeat a problematic pose identified in step 517, the application can be modified to perform that pose multiple times instead of just once. Alternatively, if the user decides to skip a specific pose due to a shoulder injury, as suggested by the AI assistant 501, the application will proceed without that particular pose.

FIG. 5D shows the flowcharts for displaying the user's current and past postures simultaneously and controlling the application's progress based on voice communication between the AI assistant 501 and the user. In step 521, the XR device 102 accesses the application server 106 for user authentication. After authentication, the application runs on the XR device 102, although it can also run on the application server 106 or a combination of both. In step 518, the XR device 102 adjusts the application's progress based on the interaction between the user and the AI assistant 501. For example, if the user wants to repeat a problematic pose identified in step 517, the application can be modified to perform that pose multiple times. Alternatively, if the user decides to skip a specific pose due to a shoulder injury, as suggested by the AI assistant 501, the application will proceed without that pose.

In step 522, the XR device 102 retrieves the user's past posture image from the user's personal data server 105. This image, which was captured during a previous workout session and stored on the personal server, serves as a useful reference for the user when performing the same workout application again. To facilitate this, it is recommended that the related application and application routine information, along with the past posture image, be stored on the user's personal server for future reference.

In step 523, the XR device 102 captures an image of the user using an external camera 103. In some cases, this camera is equipped with a 3D sensor, allowing it to transmit 3D sensing data to the XR device 102. In step 524, the XR device 102 uses the data from steps 522 and 523 to display both the user's current posture and their past corresponding posture simultaneously. For example, if the user performs the Downward-Facing Dog pose in a yoga application, the device will also display the user's past posture in the same pose. This matching can be achieved through application routine data or image analysis of the user's pose.

In step 525, the XR device 102 can display an enlarged view of both the user's current posture and their past posture simultaneously. The enlarged portion may be chosen based on the greatest difference between the user's current and past postures, or it may be selected based on the user's interest, detected through the XR device's gaze tracking feature. This helps the user to more clearly understand the differences between their current and past postures. In step 516, the XR device 102 adjusts the position, angle, or height of the external camera 103. Sometimes, it may be necessary to capture a detailed image of a specific part of the user by moving the external camera 103. Therefore, the XR device 102 can command the external camera 103 to move to a specific position or to change its shooting angle or height. The external camera 103 is equipped with mechanisms to adjust its position, angle, and height.

In step 527, the XR device 102 communicates with the user through the AI assistant 501. This communication can occur via voice or a graphical user interface (GUI) 503 displayed on the internal display 302 of the XR device 102. The AI assistant 501 can identify issues in the user's posture and suggest solutions or additional training to address these problems. In another scenario, the AI assistant 501 might access the user's medical records stored on the user's personal server and recognize a shoulder injury. In this case, the AI assistant 501 could recommend skipping shoulder-related poses to protect the user's health. In step 528, the XR device 102 adjusts the application's progress based on the interaction between the user and the AI assistant 501. For instance, if the user wants to repeat a problematic pose identified in step 527, the application can be modified to perform that pose multiple times. Alternatively, if the user decides to skip a specific pose due to a shoulder injury, as the AI assistant 501 suggested, the application will proceed without that pose.

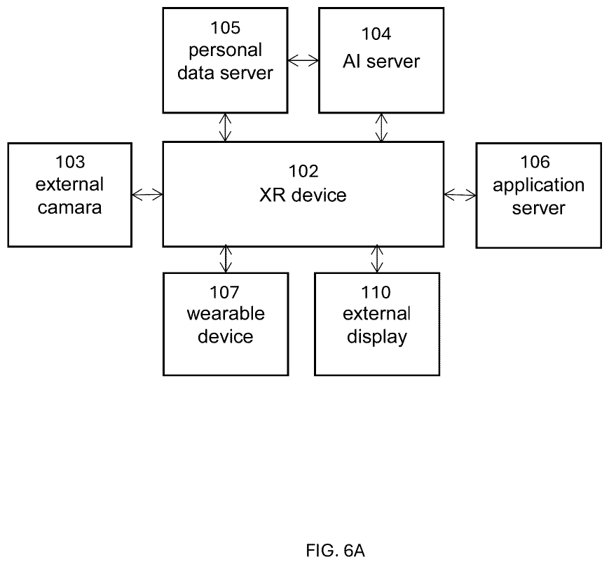

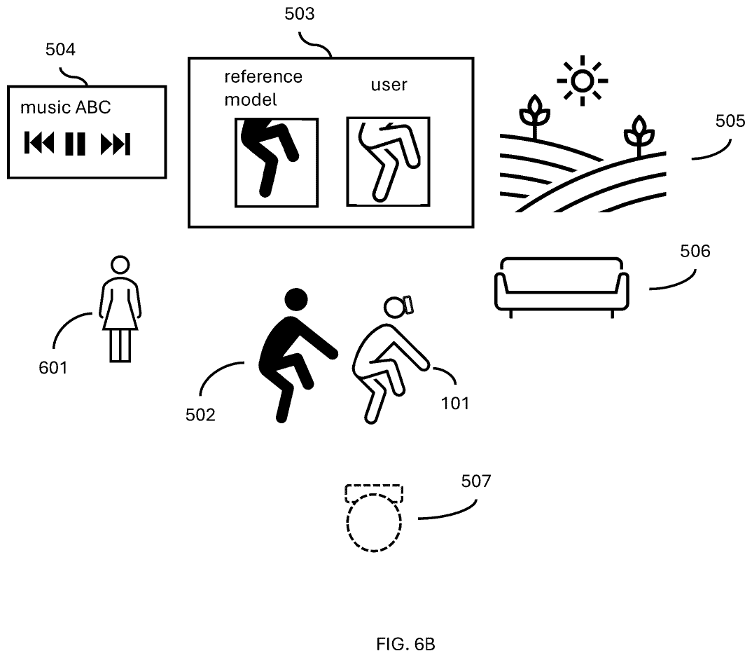

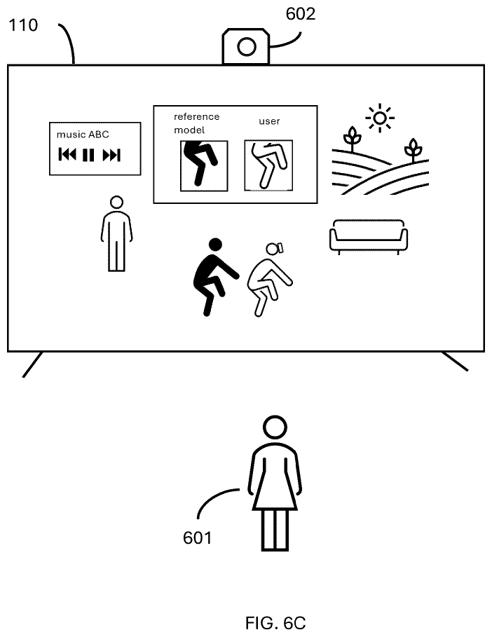

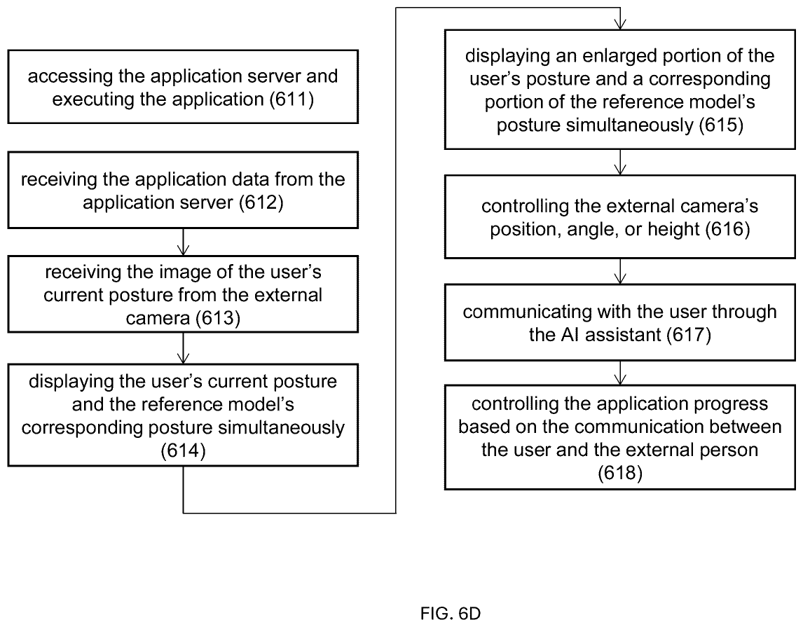

FIG. 6A illustrates block diagrams of techniques for communication between an external person 601 and an XR device 102 user. The external person views the content of the XR device's 102 internal display 302 through an external display 110. The block diagram in FIG. 6A is similar to FIG. 5A, with the addition of the external display 110 block. Since the blocks with the same names in both figures perform the same functions, additional descriptions are omitted here. The external display 110 is connected to the XR device 102 as a peripheral device, allowing the content displayed on the internal display 302 of the XR device 102 also to be shown on the external display 110. This setup enables an external person 601 to communicate with the user while viewing the same content displayed on the user's XR device 102 through the external display 110.

FIG. 6B illustrates a scene viewed by the user through the XR device's 102 internal display 302 while performing yoga exercises according to a yoga application from the application server 106. The external camera 103 captures the user performing the exercises and transmits the image to the XR device 102 in real time, which then displays it on the internal display 302. This allows the user to see their postures from the perspective of the external camera 103 through the XR device 102. Additionally, the user can view their past posture by performing the same yoga exercise next to their current posture. This past posture is a visualization of data transmitted from the user's personal server, enabling the user to compare their current posture with their past posture efficiently.

As shown in FIG. 6B, the XR device 102 can use the GUI 503 to display an enlarged view of both the current user's posture and the corresponding past user's posture side-by-side. The enlarged portion may be chosen based on the greatest difference between the user's current and past postures, or it may be selected based on the user's interest, detected through the XR device's gaze tracking feature. This helps the user to more clearly understand the differences between their current and past postures. In FIG. 6B, the AI assistant 501 from FIG. 5B is replaced by an external person 601, who can communicate with the user either by voice or through the GUI 503 provided by the XR device 102.

FIG. 6C illustrates a scenario where an external person 601 communicates with an XR device 102 user while viewing the same content displayed on the XR device's 102 internal display 302 through an external display 110. The external display 110 is equipped with a built-in camera 602, allowing the external person 601 to be captured and transmitted to the XR device 102. Consequently, the XR device 102 user can see the external person 601 on the internal display 302 during their communication.

In step 612, the XR device 102 receives application data from the application server 106. This data includes various components of the application, such as the application routine, reference model 502 data, background images 505, and background music. The application routine outlines the content and timing of sessions within the application. For instance, an indoor bodyweight workout application might include 15-minute sessions of leg squats, shoulder raises, and lunges. Similarly, a yoga application might feature 5-minute sessions of Mountain Pose, Downward-Facing Dog, and Warrior Pose. The reference model 502 data provides a model for the user to follow while using the application. In a yoga application, this could be a virtual model demonstrating ideal poses for each step, while in a bodyweight workout application, it could be a virtual model showing the correct form for each exercise. Background images 505 and music are media content displayed or played on the device running the application. Multiple background images or music tracks can be assigned to different stages of the application. Users can select these based on their preferences, or the device can automatically choose them by referencing data stored on the user's personal server or transferred from the user's wearable device.

In step 613, the XR device 102 captures an image of the user using an external camera 103. In some cases, this camera is equipped with a 3D sensor, allowing it to transmit 3D sensing data to the XR device 102. In step 614, the XR device 102 uses the data from steps 612 and 613 to display both the user's current posture and the corresponding posture of the reference model 502 simultaneously. For example, if the user performs the Downward-Facing Dog pose in a yoga application, the reference model 502 will also display the Downward-Facing Dog pose. This matching can be achieved through application routine data or image analysis of the user's pose.

In step 615, the XR device 102 can display an enlarged view of both the user's posture and the corresponding posture of the reference model 502 simultaneously. The enlarged portion may be chosen based on the greatest difference between the user's posture and the reference model's posture, or it may be selected based on the user's interest, detected through the XR device's gaze tracking feature. This helps the user to more clearly understand the differences between their posture and the reference model's posture. In step 616, the XR device 102 adjusts the position, angle, or height of the external camera 103. Sometimes, it may be necessary to capture a detailed image of a specific part of the user by moving the external camera 103. Therefore, the XR device 102 can command the external camera 103 to move to a specific position or to change its shooting angle or height. The external camera 103 is equipped with mechanisms to adjust its position, angle, and height.

In step 617, the XR device 102 communicates with the user through an external person 601. This communication can occur via voice or a graphical user interface (GUI) 503 displayed on the internal display 302 of the XR device 102. The external person 601 can identify issues in the user's posture and suggest solutions or additional training to address these problems. In another scenario, the external person 601 might access the user's medical records stored on the user's personal server and recognize a shoulder injury. In this case, the external person 601 could recommend skipping shoulder-related poses to protect the user's health. In step 618, the XR device 102 adjusts the application's progress based on the interaction between the user and the external person 601. For instance, if the user wants to repeat a problematic pose identified in step 617, the application can be modified to perform that pose multiple times. Alternatively, if the user decides to skip a specific pose due to a shoulder injury, as suggested by the external person 601, the application will proceed without that pose.

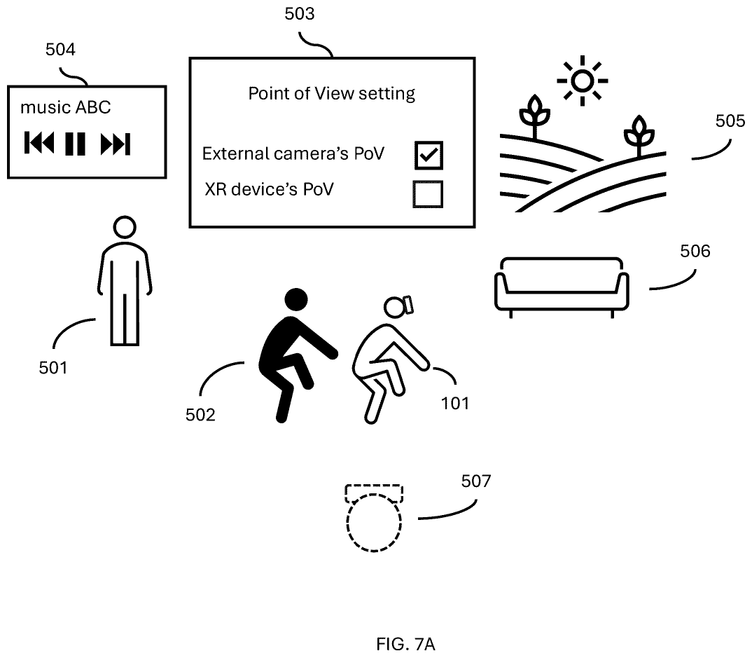

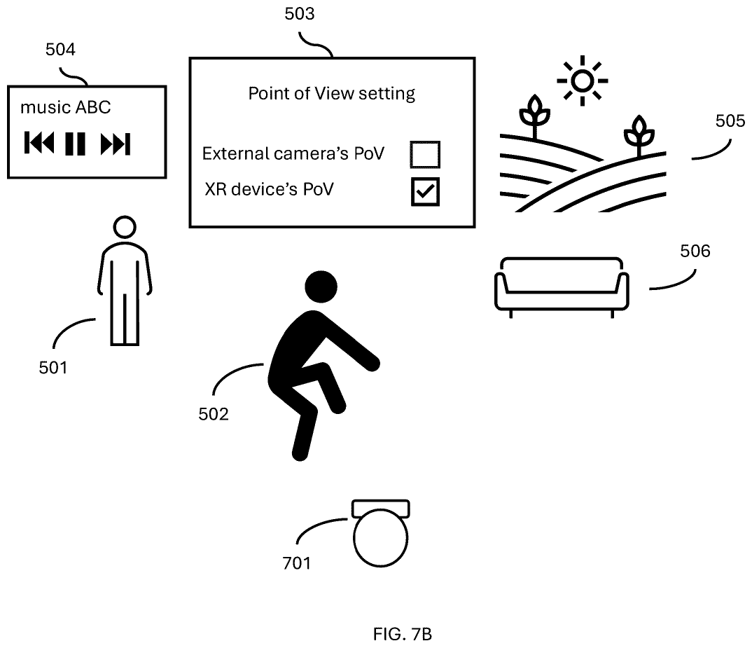

FIG. 7A shows a scene where the user's point of view is set to the external camera's 103 perspective. In this view, the user can see the AI assistant 501, reference model 502, GUI 503 screen, background image 505, and their own image captured by the external camera 103. FIG. 7B, on the other hand, illustrates the user's point of view from the XR device's 102 perspective. Here, the user can see the AI assistant 501, reference model 502, GUI 503 screen, and background image 505, but not their own image from the external camera 103. Switching between these points of view can be done based on the user's preferences via voice commands or the GUI 503. In some cases, the switch can happen automatically, depending on the type of application or the stage of the application. Regardless of the point of view, the location, representation, and function of the GUI 503 screens, background images 505, and AI assistant 501 remain unchanged.

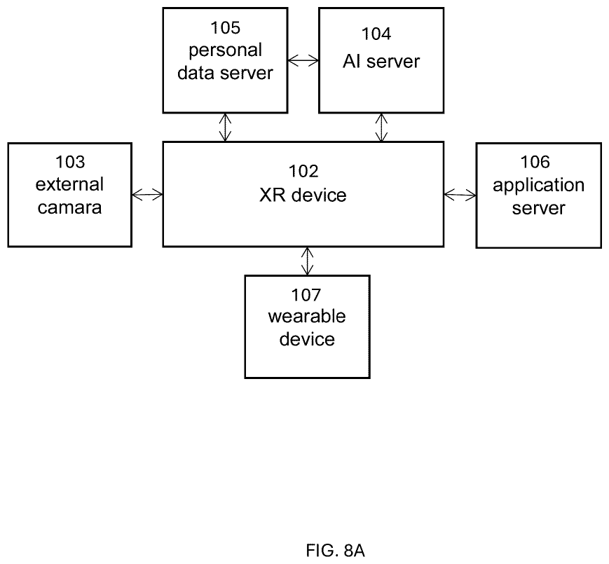

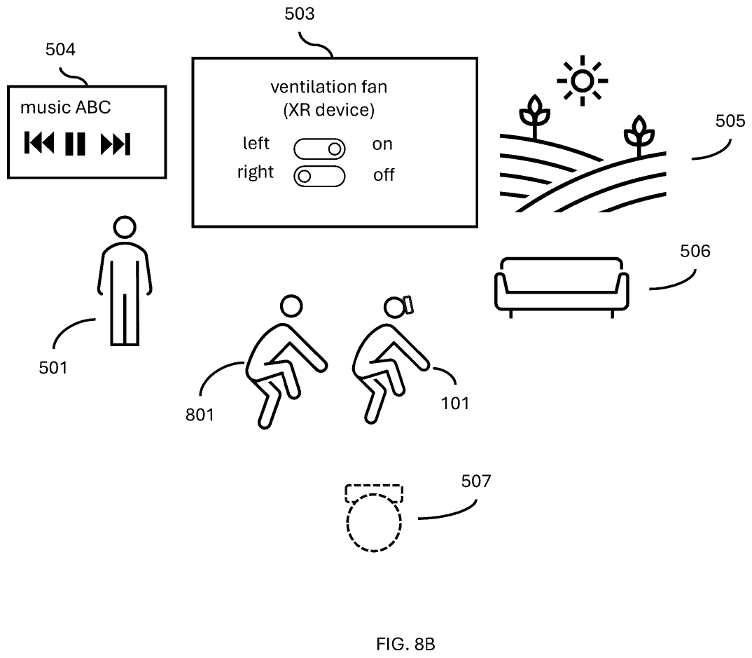

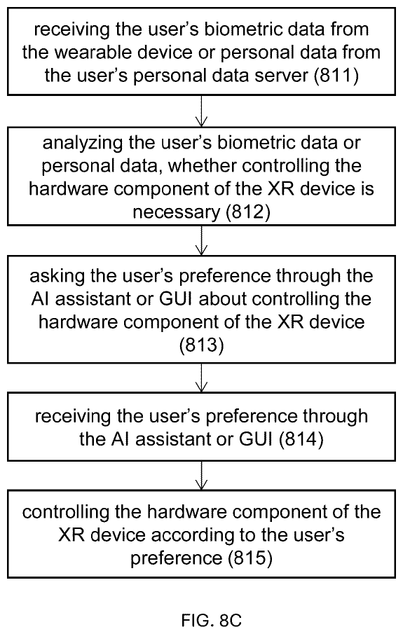

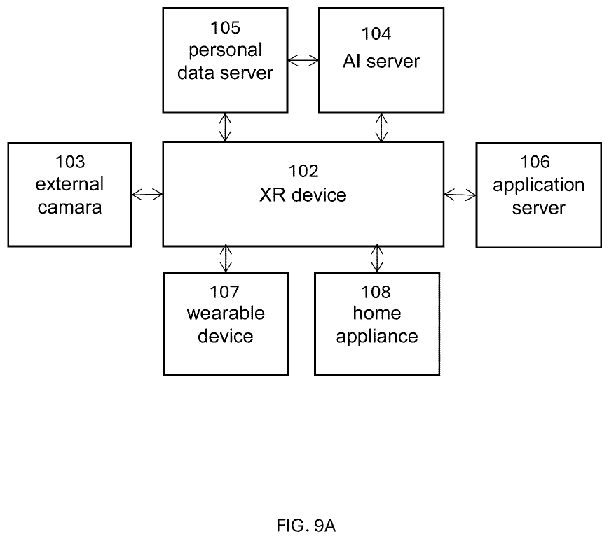

FIG. 8A illustrates techniques for controlling an XR device 102 using biometric data from the user's wearable device or personal data from the user's personal data server 105. The block diagram in FIG. 8A is identical to FIG. 5A, so additional descriptions of the blocks are omitted here as they perform the same functions.

FIG. 8B illustrates a scene where the user's point of view is set to the external camera's 103 perspective. In this view, the user can see the AI assistant 501, attendee 801, GUI 503 screen, background image 505, and their own image captured by the external camera 103. The attendee 801 represents another user connected to the network, participating in the same application as the user. The XR device 102 displays the operation state of the ventilation fan (not shown) through the GUI 503. Biometric data from the user's wearable device is used to determine if the ventilation fan needs to be operated. For instance, if the wearable device detects that the user is sweating heavily, indicating high moisture inside the XR device 102, the AI assistant 501 can recommend operating the ventilation fan via voice or GUI 503. In some cases, the ventilation fan can be controlled automatically without user intervention, based on the user's past usage history stored on their personal server.

FIG. 8C illustrates a flowchart of techniques for controlling an XR device 102 using biometric data from the user's wearable device or personal data from the user's personal data server 105. In step 811, the XR device 102 receives the user's biometric data from the wearable device or personal data from the personal data server 105. In step 812, the XR device 102 analyzes this data to determine if controlling a hardware component of the XR device 102 is necessary. In step 813, the XR device 102 asks for the user's preference regarding the control of the hardware component through the AI assistant 501 or GUI 503. In step 814, the XR device 102 receives the user's preference via the AI assistant 501 or GUI 503. In step 815, the XR device 102 controls the hardware component of the XR device 102 according to the user's preference.

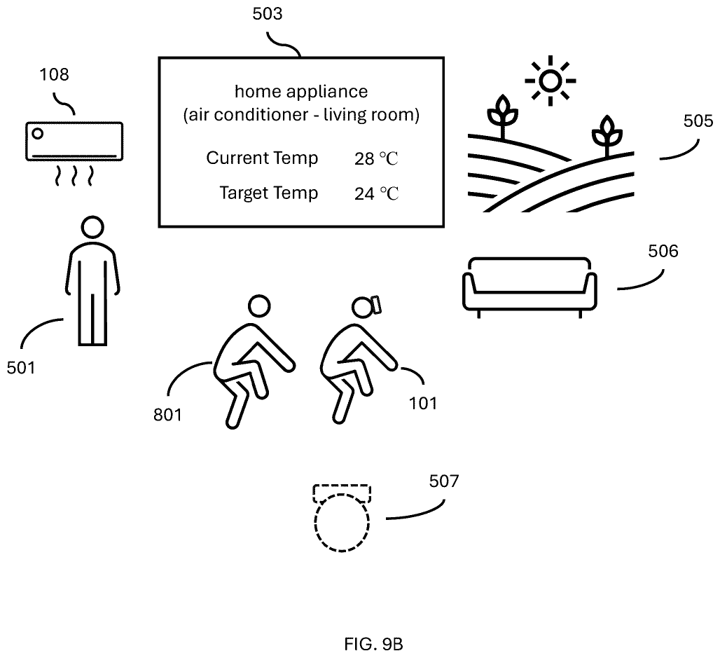

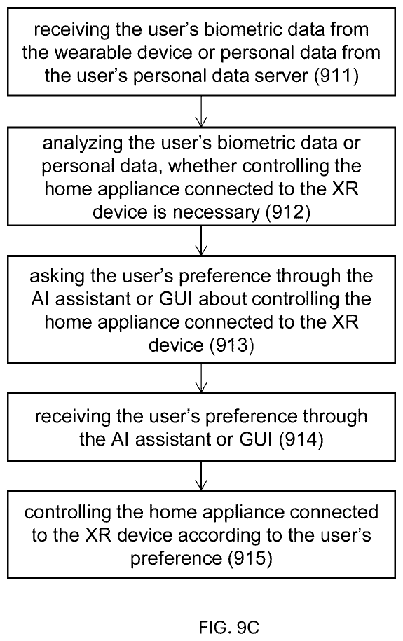

FIG. 9A illustrates techniques for controlling a home appliance 108 using biometric data from the XR device 102 user's wearable device or personal data from the user's personal data server 105. The block diagram in FIG. 9A is identical to FIG. 5A, except for the addition of the home appliance 108 block. Since the blocks with the same names in both figures perform the same functions, additional descriptions are omitted here. In this embodiment, the home appliance 108 is connected to the XR device 102 as a peripheral device. The state information of the home appliance 108 can be transmitted to the XR device 102 and displayed on its internal display 302. The operation of the home appliance 108 can be controlled through the XR device 102.

FIG. 9B illustrates a scene where the user's point of view is set to the external camera's 103 perspective. In this view, the user can see the AI assistant 501, attendee 801, GUI 503 screen, background image 505, and their own image captured by the external camera 103. The attendee 801 represents another user connected to the network, participating in the same application as the user. The XR device 102 displays the operation state of the home appliance 108, such as an air conditioner connected to the XR device 102. This connection can be made through wireless communication technologies like Wi-Fi, Bluetooth, NFC, IR, or Zigbee. In this embodiment, biometric data from the user's wearable device is used to determine if controlling the home appliance 108 is necessary. For instance, if the wearable device detects that the user is sweating heavily, it might indicate a need to change the room temperature. The AI assistant 501 can then recommend adjusting the air conditioner's target temperature via voice or GUI 503. In some cases, the air conditioner can be controlled automatically without user intervention, based on the user's past usage history stored on their personal server.

FIG. 9C illustrates a flowchart of techniques for controlling a home appliance 108 connected to the XR device 102 using biometric data from the user's wearable device or personal data from the user's personal data server 105. In step 911, the XR device 102 receives the user's biometric data from the wearable device or personal data from the personal data server 105. In step 912, the XR device 102 analyzes this data to determine if controlling the connected home appliance 108 is necessary. In step 913, the XR device 102 asks for the user's preference regarding the control of the home appliance 108 through the AI assistant 501 or GUI 503. In step 914, the XR device 102 receives the user's preference via the AI assistant 501 or GUI 503. In step 915, the XR device 102 controls the home appliance 108 according to the user's preference.

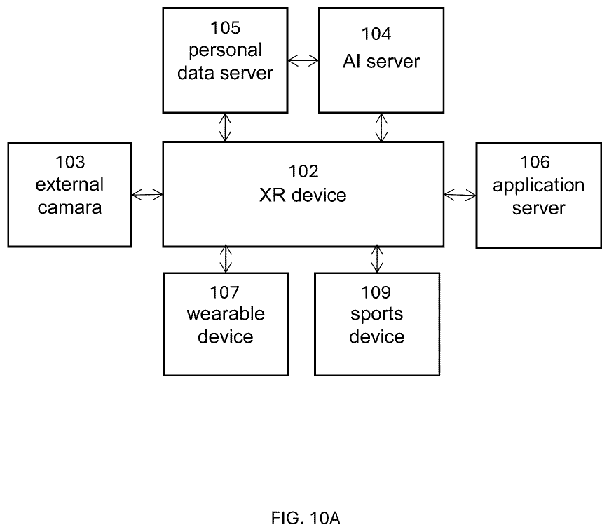

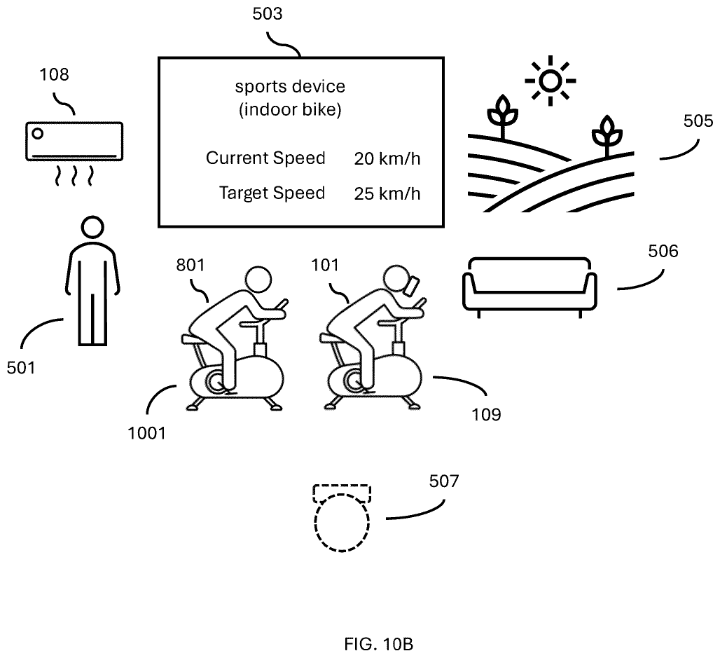

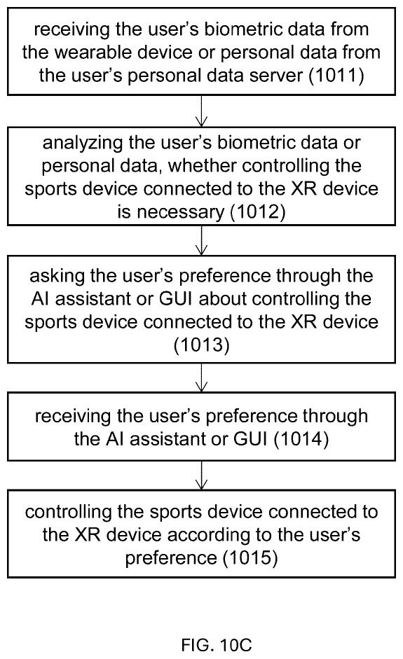

FIG. 10A illustrates techniques for controlling a sports device 109 using biometric data from the XR device 102 user's wearable device or personal data from the user's personal data server 105. The block diagram in FIG. 10A is identical to FIG. 5A, except for the addition of the sports device 109 block. Since the blocks with the same names in both figures perform the same functions, additional descriptions are omitted here. In this embodiment, the sports device 109 is connected to the XR device 102 as a peripheral device. The state information of the sports device 109 can be transmitted to the XR device 102 and displayed on its internal display 302. The operation of the sports device 109 can be controlled through the XR device 102.

FIG. 10B illustrates a scene where the user's point of view is set to the external camera's 103 perspective. In this view, the user can see the AI assistant 501, attendee 801, GUI 503 screen, background image 505, and their own image captured by the external camera 103. The attendee 801 represents another user connected to the network, participating in the same application as the user. The XR device 102 displays the operation state of the sports device 109, such as an indoor bike, connected to the XR device 102. This connection can be made through wireless communication technologies like Wi-Fi, Bluetooth, NFC, IR, or Zigbee. In this embodiment, biometric data from the user's wearable device is used to determine if controlling the sports device 109 is necessary. For instance, if the wearable device detects that the user is sweating heavily, it might indicate a need to change the room temperature. The AI assistant 501 can then recommend adjusting the indoor bike's target temperature via voice or GUI 503. In some cases, the indoor bike can be controlled automatically without user intervention, based on the user's past usage history stored on their personal server.

FIG. 10C illustrates a flowchart of techniques for controlling a sports device 109 connected to the XR device 102 using biometric data from the user's wearable device or personal data from the user's personal data server 105. In step 1011, the XR device 102 receives the user's biometric data from the wearable device or personal data from the personal data server 105. In step 1012, the XR device 102 analyzes this data to determine if controlling the connected sports device 109 is necessary. In step 1013, the XR device 102 asks for the user's preference regarding the control of the sports device 109 through the AI assistant 501 or GUI 503. In step 1014, the XR device 102 receives the user's preference via the AI assistant 501 or GUI 503. In step 1015, the XR device 102 controls the sports device 109 according to the user's preference.

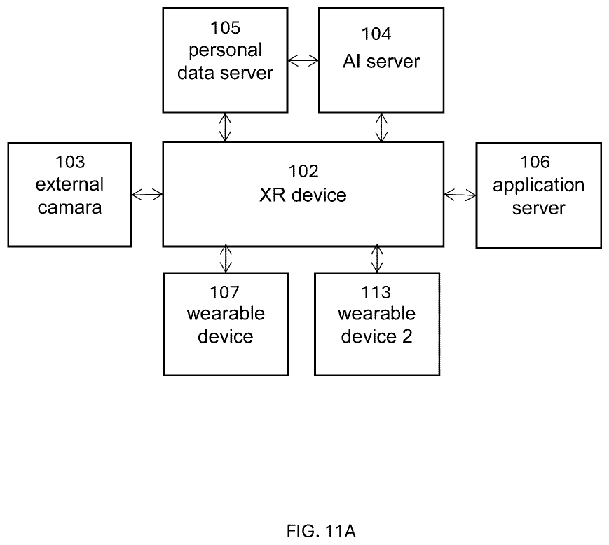

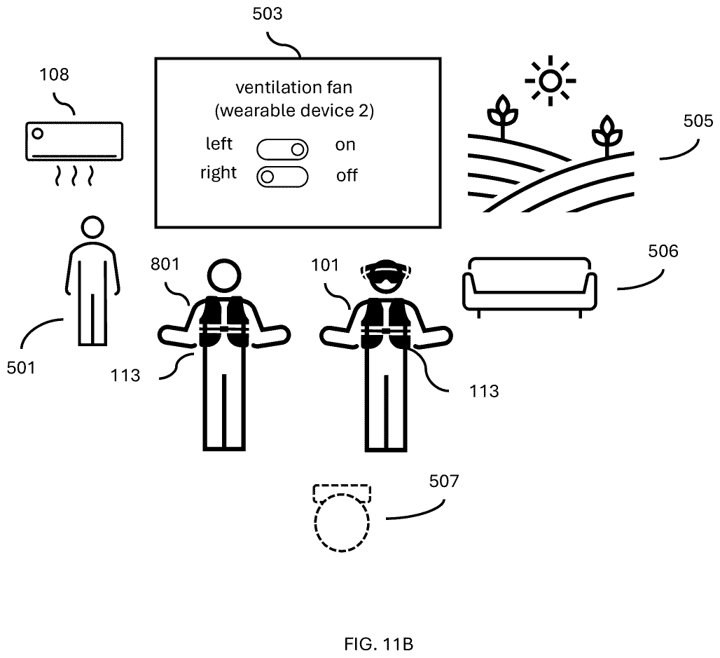

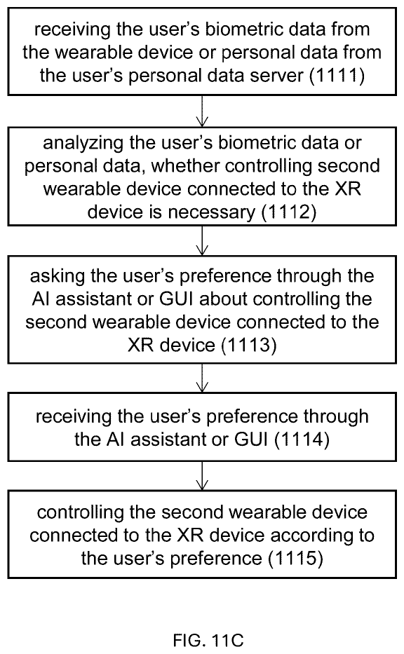

FIG. 11A illustrates techniques for controlling a second wearable device 113 using biometric data from the XR device 102 user's primary wearable device or personal data from the user's personal data server 105. The block diagram in FIG. 11A is identical to FIG. 5A, except for the addition of the wearable device 2 113 block. Since the blocks with the same names in both figures perform the same functions, additional descriptions are omitted here. In this embodiment, the wearable device 2 113 is connected to the XR device 102 as a peripheral device. The state information of the wearable device 2 113 can be transmitted to the XR device 102 and displayed on its internal display 302. The operation of the wearable device 2 113 can be controlled through the XR device 102.

In FIG. 11B, the user's point of view is set to the external camera's 103 perspective. In this view, the user can see the AI assistant 501, attendee 801, GUI 503 screen, background image 505, and their own image captured by the external camera 103. The attendee 801 represents another user connected to the network, participating in the same application as the user. The XR device 102 displays the operation state of the wearable device 2 113, such as a smart vest connected to the XR device 102. This connection can be made through wireless communication technologies like Wi-Fi, Bluetooth, NFC, IR, or Zigbee. In this embodiment, biometric data from the user's wearable device is used to determine if controlling the wearable device 2 113 is necessary. For instance, if the wearable device detects that the user is sweating heavily, it might indicate a need to change the room temperature. The AI assistant 501 can then recommend adjusting the smart vest's target temperature via voice or GUI 503. In some cases, the smart vest can be controlled automatically without user intervention, based on the user's past usage history stored on their personal server.

FIG. 11C illustrates a flowchart outlining the procedures for controlling the wearable device 2 113 connected to the XR device 102 based on biometric data from the wearable device of the XR device 102 user or personal data from the user's personal data server 105. In step 1111, the XR device 102 obtains the user's biometric data from the wearable device or personal data from the user's personal data server 105. In step 1112, the XR device 102 analyzes this data to determine the necessity of controlling the wearable device 2 113 connected to the XR device 102. In step 1113, the XR device 102 solicits the user's preference via the AI assistant 501 or GUI 503 regarding the control of the wearable device 2 113. In step 1114, the XR device 102 receives the user's preference through the AI assistant 501 or GUI 503. Finally, in step 1115, the XR device 102 controls the wearable device 2 113 according to the user's preference.

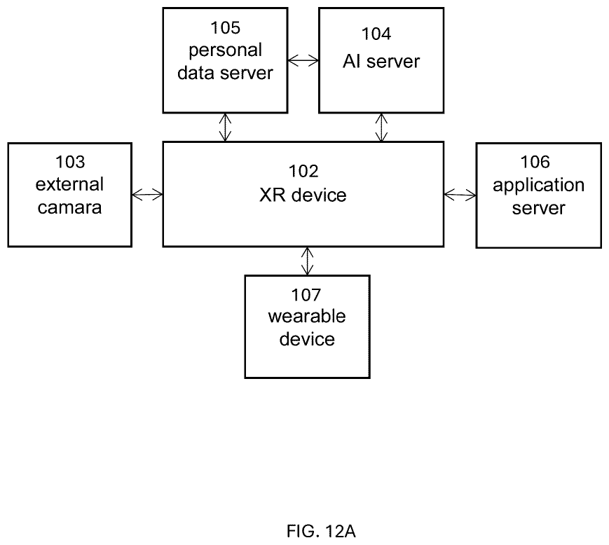

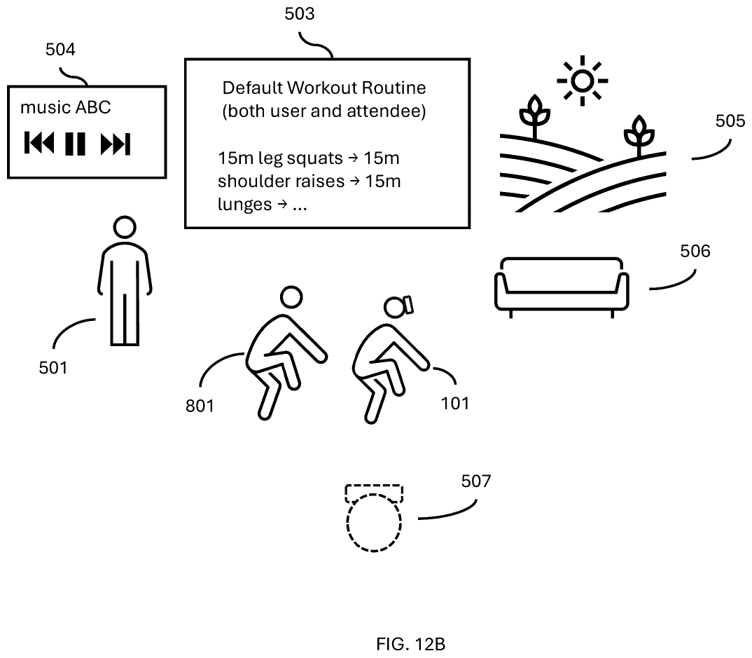

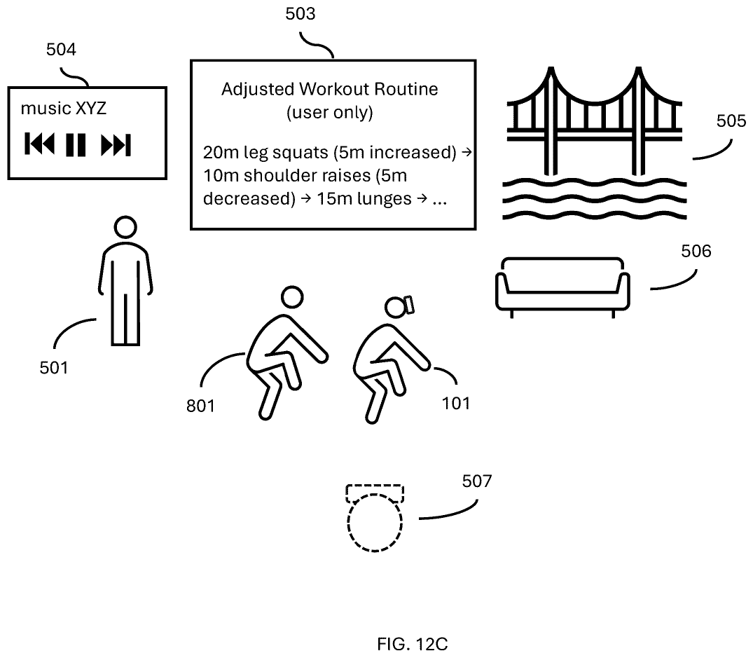

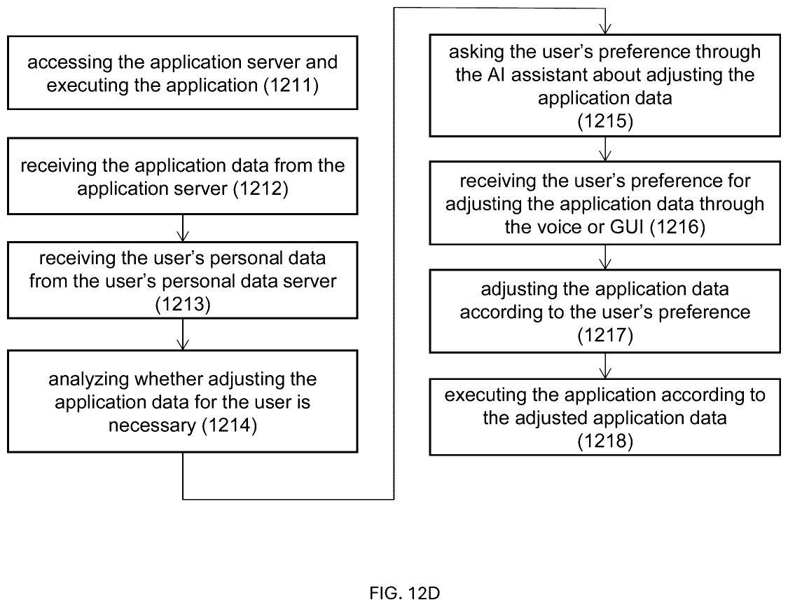

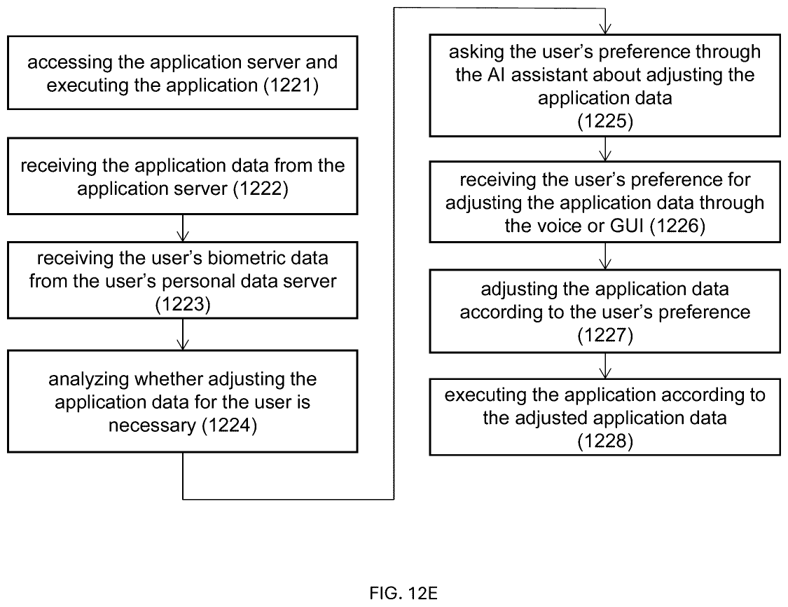

FIG. 12A demonstrates example methods for managing application progress using biometric data from the XR device 102 user's wearable device or personal data from the user's personal data server 105. The block diagram in FIG. 12A is identical to that in FIG. 5A. As the blocks with the same names in both figures serve the same functions, further descriptions are omitted in this section.

FIGS. 12B and 12C depict scenes from the user's perspective, as selected for the external camera 103's point of view (PoV). In this PoV, the user can see the AI assistant 501, attendee 801, GUI 503 screen, background image 505, and their own image captured by the external camera 103. The attendee 801 represents another user connected to the network and participating in the same application. FIG. 12B shows the user following the default workout routine (15 minutes leg squats→15 minutes shoulder raises→15 minutes lunges, etc.) of the workout application while listening to music (ABC) and viewing the background image 505 of sunny hills. FIG. 12C illustrates the user following an adjusted workout routine (15 minutes leg squats→10 minutes shoulder raises (reduced by 5 minutes)→20 minutes lunges (increased by 5 minutes), etc.) while listening to different music (XYZ) and viewing a different background image 505 of a river bridge.

The difference between these two scenarios is that in the second scenario, the XR device 102 adjusts the workout routine, background image 505, and music based on biometric data from the user's wearable device or personal data from the user's personal data server 105. For example, in FIG. 12C, the XR device 102 reduces the shoulder-related workout from 15 to 5 minutes after referencing the user's medical records for a shoulder injury stored on the personal server. It increases the leg-related workout from 15 to 20 minutes. Additionally, upon detecting an increased heart rate from the wearable device, the XR device 102 changes the music from ABC to XYZ, which has a faster pace to match the user's increased heart rate. It also changes the background image 505 from sunny hills to a river bridge to provide a cooler and more refreshing visual experience after detecting an increased body temperature. These adjustments to workout routines, background images 505, and music can be communicated between the AI assistant 501 and the user via voice or GUI 503. In some embodiments, the AI assistant 501 can make these adjustments autonomously, referencing the user's past records from similar situations.

FIG. 12D presents a flowchart detailing example methods for adjusting application data, such as application routines, based on the user's personal data received from the user's personal data server 105. In step 1211, the XR device 102 accesses the application server 106 to perform user authentication procedures. Following authentication, the application is executed on the XR device 102. However, in some embodiments, the application may be executed on the application server 106 or a combination of both the application server 106 and the XR device 102.

In step 1212, the XR device 102 receives application data from the application server 106. This data encompasses various elements constituting the application, such as application routines, reference model 502 data, background images 505, and background music. The application routine specifies the content and duration of sessions within the application. For instance, an indoor bodyweight workout application might include 15-minute leg squats, 15-minute shoulder raises, and 15-minute lunges. Similarly, a yoga application might consist of 5-minute Mountain Pose, 5-minute Downward-Facing Dog, and 5-minute Warrior. he reference model 502 data provides a model for the user to follow during the application. In a yoga application, this could be a virtual model demonstrating ideal poses for each step, while in an indoor bodyweight workout application, it could be a virtual model performing ideal exercises. Background images 505 and music are media content displayed or played on the device running the application. Multiple background images 505 or music tracks are designated for each stage of the application. The user can select these according to their preference, or the device may automatically select them based on data stored in the user's personal server or data transmitted from the user's wearable device.

In step 1213, the XR device 102 receives the user's personal data, such as medical records, past activity records, and schedules. In step 1214, the XR device 102 analyzes this personal data to determine if adjustments to the application data, such as the application routine, background image 505, or background music, are necessary. For instance, if the XR device 102 identifies a shoulder injury from the user's personal data, it may modify the shoulder-related portion of the workout application accordingly. In step 1215, the XR device 102, via the AI assistant 501, solicits the user's preference regarding these adjustments. The user might be asked if they agree with the proposed modification to the shoulder-related part of the workout application. In step 1216, the XR device 102 receives the user's preference for adjusting the application data. In step 1217, the XR device 102 adjusts the application data, such as the application routine, based on the user's preference. Finally, in step 1218, the XR device 102 executes the application according to the adjusted application data.

FIG. 12E presents a flowchart detailing example methods for adjusting application data, such as background images 505 or music, based on the user's biometric data received from their wearable devices. In step 1221, the XR device 102 accesses the application server 106 to perform user authentication procedures. Following authentication, the application is executed on the XR device 102. However, in some embodiments, the application may be executed on the application server 106 or a combination of both the application server 106 and the XR device 102.

In step 1222, the XR device 102 receives application data from the application server 106. This data includes various elements constituting the application, such as application routines, reference model 502 data, background images 505, and background music. The application routine specifies the content and duration of sessions within the application. For instance, an indoor bodyweight workout application might include 15-minute leg squats, 15-minute shoulder raises, and 15-minute lunges. Similarly, a yoga application might consist of a 5-minute Mountain Pose, a 5-minute Downward-Facing Dog, and a 5-minute Warrior. The reference model 502 data provides a model for the user to follow during the application. In a yoga application, this could be a virtual model demonstrating ideal poses for each step, while in an indoor bodyweight workout application, it could be a virtual model performing ideal exercises. Background images 505 and music are media content displayed or played on the device running the application. Multiple background images 505 or music tracks are designated for each stage of the application. The user can select these according to their preference, or the device may automatically select them based on data stored in the user's personal server or data transmitted from the user's wearable device.

In step 1223, the XR device 102 receives the user's biometric data, such as heart rate, body temperature, and sweat release. In step 1224, the XR device 102 analyzes this biometric data to determine if adjustments to the application data, such as the application routine, background image 505, or background music, are necessary. For instance, if the XR device 102 detects an elevated heart rate, it may adjust the background music or image of the workout application accordingly. In step 1225, the XR device 102, via the AI assistant 501, solicits the user's preference regarding these adjustments. The user might be asked if they agree with the proposed changes to the background music or image of the workout application. In step 1226, the XR device 102 receives the user's preference for adjusting the application data. In step 1227, the XR device 102 adjusts the application data, such as the background music or image, based on the user's preference. Finally, in step 1228, the XR device 102 executes the application according to the adjusted application data.

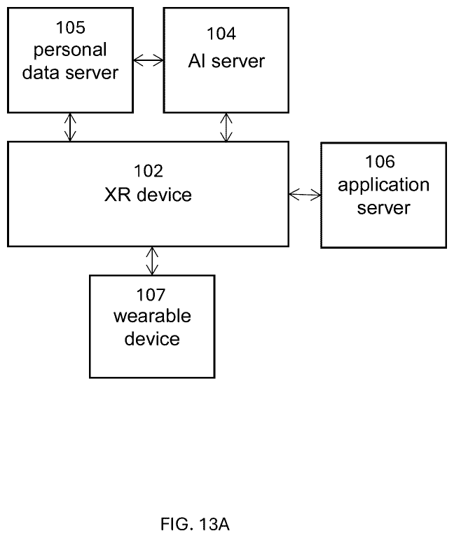

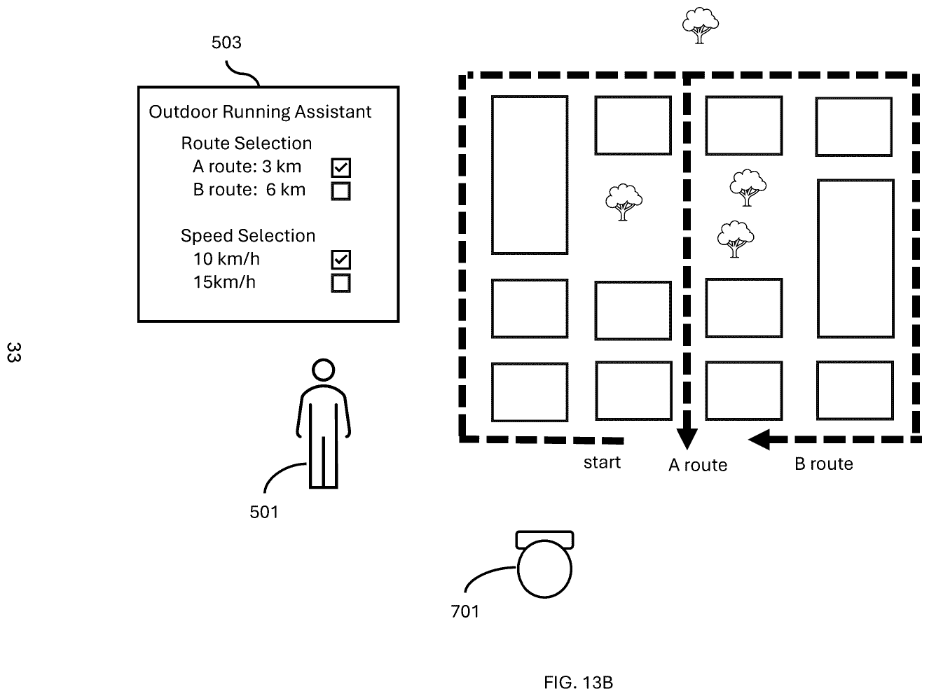

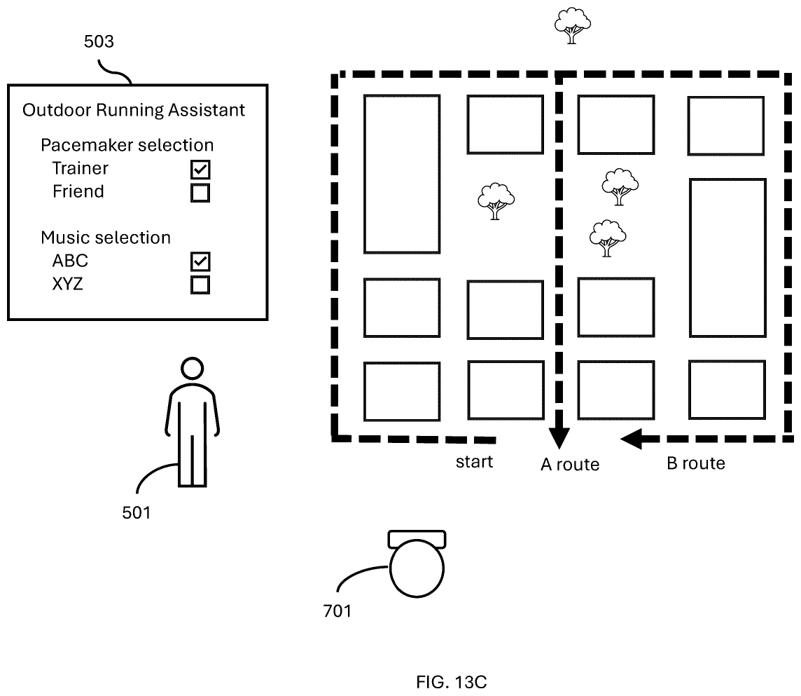

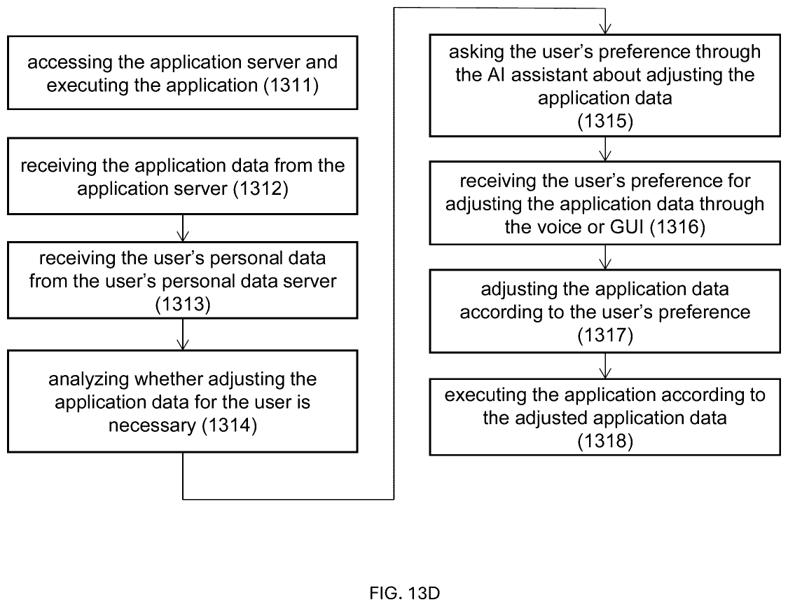

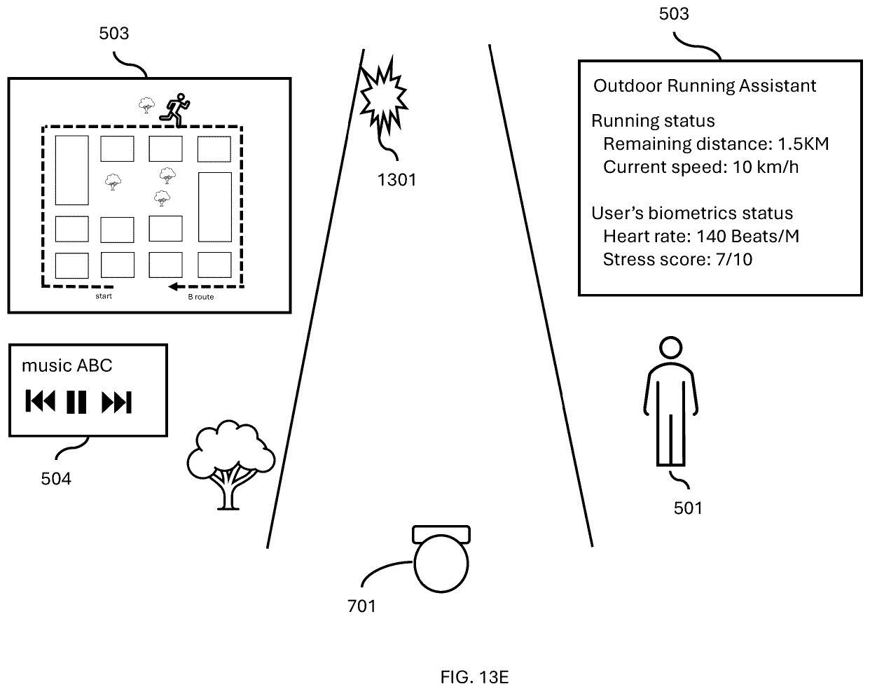

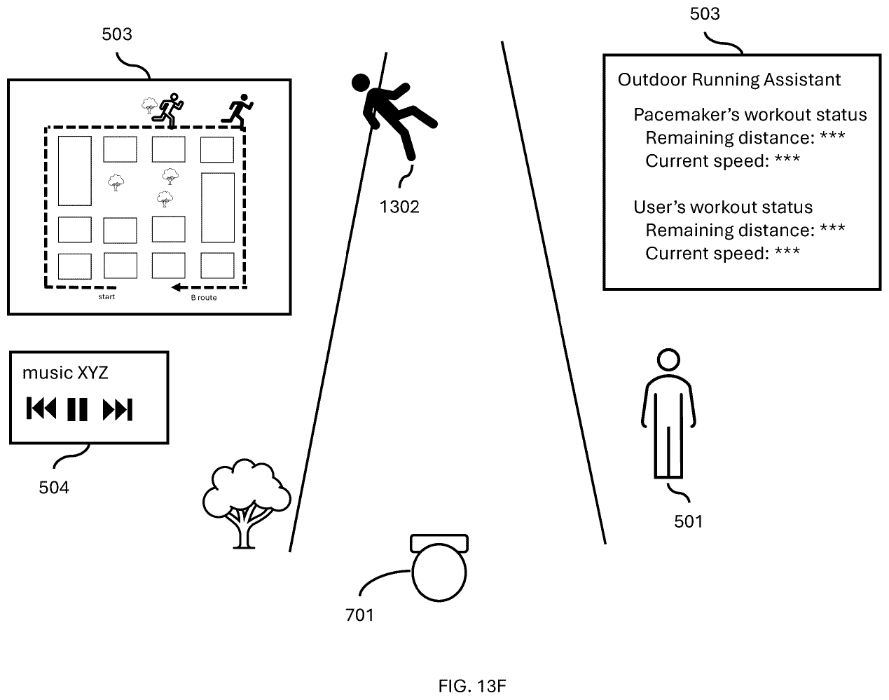

FIG. 13A demonstrates example methods for managing application progress using biometric data from the XR device 102 user's wearable device or personal data from the user's personal data server 105. The block diagram in FIG. 13A is identical to that in FIG. 5A. As the blocks with the same names in both figures serve the same functions, further descriptions are omitted in this section.

FIGS. 13B and 13C depict the initial screens displayed to the user through the internal display 302 of the XR device 102 when the user initiates a running application while wearing the XR device 102. According to the present invention, the XR device 102 captures the external environment using a camera (not shown) mounted on the device and displays this environment on the internal display 302 in real time. This functionality allows the user to view the external environment as if they were wearing transparent glasses, enabling them to run outdoors while using the running application.

As shown in FIG. 13B, the user can select the running route and speed through communication with the AI assistant 501 and GUI 503 before starting the run. According to the present invention, the AI assistant 501 may recommend an appropriate route or speed by checking the user's activity record on their personal server or referring to biometric data transmitted from the user's wearable device. For example, if the user's personal data indicates excessive exercise the previous day, the AI assistant 501 might recommend a 3 km A course instead of a 6 km B course and a running speed of 10 km/h instead of 15 km/h.

FIG. 13D illustrates a flowchart of example techniques for adjusting application data, such as application routines, based on the user's personal data received from the user's personal data server 105. In step 1311, the XR device 102 accesses the application server 106 for the user authentication procedures. After the authentication, the application is executed on the XR device 102, but in some embodiments, the application can be executed on the application server 106. In some embodiments, the application can be executed on the application server 106 and the XR device 102 in combination. As shown in FIG. 13C, the user can select a virtual pacemaker and music through communication with the AI assistant 501 and GUI 503 before starting the run. The AI assistant 501 may recommend an appropriate pacemaker or music by checking the user's activity record on their personal server or referring to biometric data from the user's wearable device. For instance, if the user's personal data indicates a scheduled running contest in a few days, the AI assistant 501 might recommend a trainer mode pacemaker instead of a friend mode pacemaker and music with a faster beat (ABC) instead of slower music (XYZ).

In step 1312, the XR device 102 receives application data from the application server 106. This data includes various elements constituting the application, such as application routines, reference model 502 data, background images 505, and background music. The application routine specifies the content and duration of sessions within the application. For instance, an outdoor running application might include various running courses and speeds tailored to specific locations. The reference model 502 data provides a model for the user to follow during the application. In the case of an outdoor running application, this could be a virtual pacemaker that runs alongside the user. Background images 505 and music are media content displayed or played on the device running the application. Multiple background images 505 or music tracks are designated for each stage of the application. The user can select these according to their preference, or the device may automatically select them based on data stored in the user's personal server or data transmitted from the user's wearable device.

In step 1313, the XR device 102 receives the user's personal data, such as medical records, past activity records, and schedules. In step 1314, the XR device 102 analyzes this personal data to determine if adjustments to the application data, such as the application routine, background image 505, or background music, are necessary. For example, if the XR device 102 identifies an ankle injury from the user's personal data, it may decide to modify the ankle-related portion of the workout application accordingly. Similarly, if the XR device 102 detects an illness through biometric signals from the user's wearable device, it may determine that the overall progress of the workout application should be adjusted. In step 1315, the XR device 102, via the AI assistant 501, solicits the user's preference regarding these adjustments. The user might be asked if they agree with the proposed changes to the course or speed of the outdoor running application. In step 1316, the XR device 102 receives the user's preference for adjusting the application data. In step 1317, the XR device 102 adjusts the application data, such as the application routine, based on the user's preference. Finally, in step 1318, the XR device 102 executes the application according to the adjusted application data.

FIG. 13E describes the screen displayed to the user through the internal display 302 of the XR device 102 when the user initiates a running application while wearing the XR device 102. According to the present invention, the XR device 102 captures the external environment using a camera (not shown) mounted on the device and displays this environment on the internal display 302 in real time. This functionality allows the user to view the external environment as if they were wearing transparent glasses, enabling them to run outdoors while using the running application.

As shown in FIG. 13E, the user can view their current location, remaining distance, current speed, heart rate, and stress score for the entire running route through the GUI 503 screen. Additionally, the user can see which music is currently playing on the media player 504. If a dangerous object is detected on the road, the XR device 102 will highlight it with a separate icon or color to help the user recognize the danger in advance. The GUI 503 screen, according to the present invention, automatically increases transparency when executing an outdoor running application, allowing the user to readily respond to unexpected situations, such as the sudden appearance of an obstacle.

FIG. 13F describes the screen displayed to the user through the internal display 302 of the XR device 102 when the user initiates a running application while wearing the XR device 102. As shown in FIG. 13F, the pacemaker is virtually displayed on the road where the user is running. The GUI 503 also shows the current positions, remaining distance, and speed of both the user and the pacemaker. Additionally, the media player 504 has changed the music from ABC to XYZ based on the user's biometric signals transmitted from their wearable devices.

Each of the aforementioned embodiments is interconnected rather than isolated. Therefore, the technologies described in one embodiment can be applied to another.

What is claimed is:

1. An Extended Reality (XR) device that is in communication with an external camera, the XR device comprising:
one or more processors; and
memory storing one or more programs configured to be executed by the one or more processors, the one or more programs including instructions for:
accessing the application server and executing the application;
receiving the reference model data from the application server; and
displaying the user's current posture and the reference model's corresponding posture simultaneously.

2. The XR device of claim 1, the one or more programs further including instructions for:
displaying an enlarged portion of the user's posture and a corresponding portion of the reference model's posture simultaneously.

3. The XR device of claim 2, wherein an enlarged portion of the user's posture and a corresponding portion of the reference model's posture are displayed side by side.

4. The XR device of claim 2, wherein an enlarged portion of the user's posture and a corresponding portion of the reference model's posture are displayed in an overlapping manner.

5. The XR device of claim 1, the one or more programs further including instructions for:
controlling the external camera's position, angle, zoom or height.

6. The XR device of claim 1, the one or more programs further including instructions for:
communicating with the XR device user through the AI assistant; and
controlling the application progress based on the communication between the user and the AI assistant.

7. The XR device of claim 1, the one or more programs further including instructions for:
changing the XR device's point of view from the external camera's point of view to the XR device's point of view.

8. The XR device of claim 1, wherein the change of point of view is performed according to the user's preference.

9. The XR device of claim 1, wherein the change of point of view is performed without the user's intervention.

10. A method for operating an Extended Reality (XR) device in communication with an external camera, the method comprising:
executing, by one or more processors, one or more programs stored in memory, the one or more programs including instructions for:
accessing an application server and executing the application;
receiving reference model data from the application server; and
displaying the user's current posture and the reference model's corresponding posture simultaneously.

11. The method of claim 10, further comprising:
displaying an enlarged portion of the user's posture and a corresponding portion of the reference model's posture simultaneously.

12. The method of claim 11, wherein the enlarged portion of the user's posture and the corresponding portion of the reference model's posture are displayed side by side.

13. The method of claim 11, wherein the enlarged portion of the user's posture and the corresponding portion of the reference model's posture are displayed in an overlapping manner.

14. The method of claim 10, further comprising:
controlling the external camera's position, angle, zoom, or height.

15. The method of claim 10, further comprising:
communicating with the XR device user through an AI assistant; and
controlling the application progress based on the communication between the user and the AI assistant.

16. The method of claim 10, further comprising:
changing the XR device's point of view from the external camera's point of view to the XR device's point of view.

17. The method of claim 10, wherein the change of point of view is performed according to the user's preference.

18. The method of claim 10, wherein the change of point of view is performed without the user's intervention.
